(19) United States
(12) Patent Application Publication
(10) Pub. No.: US 2020/0106953 A1
(43) Pub. Date: Apr. 2, 2020

(54) OBJECT DETECTION APPARATUS, IMAGE APPARATUS, OBJECT DETECTION METHOD, AND COMPUTER READABLE RECORDING MEDIUM

(71) Applicant: Olympus Corporation, Tokyo (JP)

(72) Inventors: Takeshi SUZUKI, Tokyo (JP); Akira YUKITAKE, Tokyo (JP); Yuki MISHIO, Tokyo (JP); Keiji KUNISHIGE, Tokyo (JP)

(21) Appl. No.: 16/526,893

(22) Filed: Jul. 30, 2019

(30) Foreign Application Priority Data
Sep. 28, 2018 (JP) 2018-185944

(51) Int. Cl. H04N 5/232; G06T 7/20; G06T 7/70; G06T 7/00; H04N 5/225; G06F 3/041

(52) U.S. Cl. CPC H04N 5/23218; G06T 7/20; G06T 7/70; G06T 2207/10016; H04N 5/22525; G06F 3/041; H04N 5/23212; G06T 7/97

(57) ABSTRACT

An object detection apparatus includes a processor including hardware, the processor being configured to: sequentially acquire image data; detect a plurality of objects that appear in an image corresponding to the image data every time the image data is acquired; set a priority of each of the objects; change the priority of each of the objects based on a detection result; and change an imaging parameter at a time of imaging, based on an object with a high priority.

This application is based upon and claims the benefit of priority from Japanese Patent Application No. 2018-185944, filed on Sep. 28, 2018, the entire contents of which are incorporated herein by reference.

### BACKGROUND

The present disclosure relates to an object detection apparatus, an image apparatus, an object detection method, and a computer readable recording medium.

In an image apparatus, such as a digital camera, a technique for detecting a plurality of objects that appear in an image, setting priorities of the detected objects, and setting an imaging condition by adopting an object with a high priority as an object of interest has been known (for example, JP 2010-87572 A). In this technique, when faces of a plurality of objects that appear in an image are detected, a detection frame is displayed for each of the faces of the objects such that the face of the object of interest is displayed with the detection frame different from those of the faces of the other objects in order to allow a user to intuitively recognize the object of interest.

Further, in the image apparatus, a technique for calculating a degree of priority for determining a priority of each of objects, and determining the priority of each of the objects based on the degree of priority has been known (for example, JP 2010-141616 A). In this technique, the degree of priority is calculated based on a size and a position of each of the objects and the recently determined priority in order to provide an appropriate priority.

### SUMMARY

An object detection apparatus according to one aspect of the present disclosure includes a processor including hardware, the processor being configured to: sequentially acquire image data; detect a plurality of objects that appear in an image corresponding to the image data every time the image data is acquired; set a priority of each of the objects; change the priority of each of the objects based on a detection result; and change an imaging parameter at a time of imaging, based on an object with a high priority.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view illustrating a schematic configuration of an image apparatus according to a first embodiment;

FIG. 2 is a block diagram illustrating a functional configuration of the image apparatus according to the first embodiment;

FIG. 3 is a block diagram illustrating a functional configuration of a system control unit according to the first embodiment;

FIG. 4 is a schematic diagram for explaining an outline of an operation process performed by the image apparatus according to the first embodiment;

FIG. 5 is a flowchart illustrating an outline of a process performed by the image apparatus according to the first embodiment;

FIG. 6 is a flowchart illustrating an outline of a live view image object detection process in FIG. 5;

FIG. 7 is a schematic diagram for explaining an outline of an operation process performed by an image apparatus 100 according to the second embodiment;

FIG. 8 is a flowchart illustrating an outline of a live view image object detection process performed by the image apparatus 100 according to the second embodiment;

FIG. 9 is a block diagram illustrating a detailed configuration of a system control unit according to a third embodiment;

FIG. 10 is a schematic diagram for explaining an outline of an operation process performed by an image apparatus according to the third embodiment;

FIG. 11 is a flowchart illustrating an outline of a live view image object detection process performed by the image apparatus according to the third embodiment;

FIG. 12 is a diagram for explaining an outline of an operation process performed by an image apparatus according to a fourth embodiment;

FIG. 13 is a diagram schematically illustrating transition of images corresponding to pieces of image data that are sequentially generated by the image apparatus in the situation illustrated in FIG. 12;

FIG. 14 is a flowchart illustrating an outline of a live view image object detection process performed by the image apparatus according to the fourth embodiment;

FIG. 15 is a diagram for explaining an outline of an operation process performed by an image apparatus according to a fifth embodiment;

FIG. 16 is a diagram illustrating a state in which a user presses a shutter button halfway;

FIG. 17 is a diagram for explaining an outline of an operation process performed by the image apparatus according to the fifth embodiment at the time of cancel operation;

FIG. 18 is a diagram illustrating a state in which a user presses a shutter button halfway;

FIG. 19 is a flowchart illustrating an outline of an imaging preparation operation process performed by the image apparatus according to the fifth embodiment;

FIG. 20 is a flowchart illustrating an outline of a priority change cancel operation process in FIG. 19;

FIG. 21 is a flowchart illustrating an outline of a live view image object detection process performed by the image apparatus 100 according to the fifth embodiment;

FIG. 22 is a diagram for explaining an outline of an operation process performed by an image apparatus 100 according to a sixth embodiment;

FIG. 23 is a diagram for explaining an outline of an operation process performed by an image apparatus according to a seventh embodiment;

FIG. 24 is a flowchart illustrating an outline of a live view image object detection process performed by the image apparatus according to the seventh embodiment; and

FIG. 25 is a flowchart illustrating an outline of a touch process performed at Step 5812 in FIG. 24.

### DETAILED DESCRIPTION

Exemplary embodiments of the present disclosure will be described in detail below with reference to the drawings. The present disclosure is not limited by the embodiments below. Further, in the drawings referred to in the following description, shapes, sizes, and positional relationships are only schematically illustrated so that the content of the present disclosure may be understood. In other words, the present disclosure is not limited to only the shapes, the sizes, and the positional relationship illustrated in the drawings. Furthermore, in the following description, an example will be described in which an image apparatus including an image processing apparatus is adopted, but the present disclosure may be applied to a mobile phone, a camcorder, an integrated circuit (IC) recorder with an imaging function, a microscope, such as a video microscope or a biological microscope, an industrial endoscope, a medical endoscope, a tablet terminal device, a personal computer, and the like, in addition to the image apparatus.

### First Embodiment

Configuration of Image Apparatus

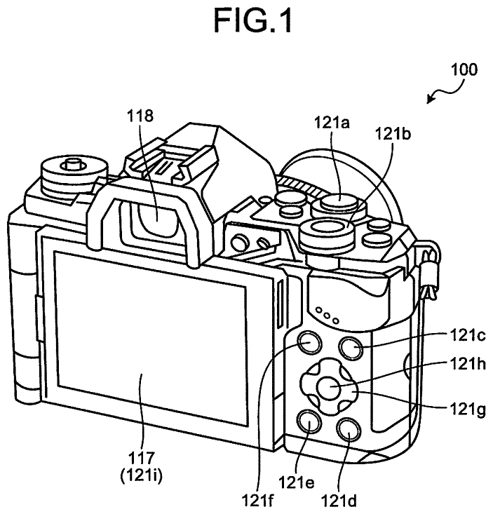

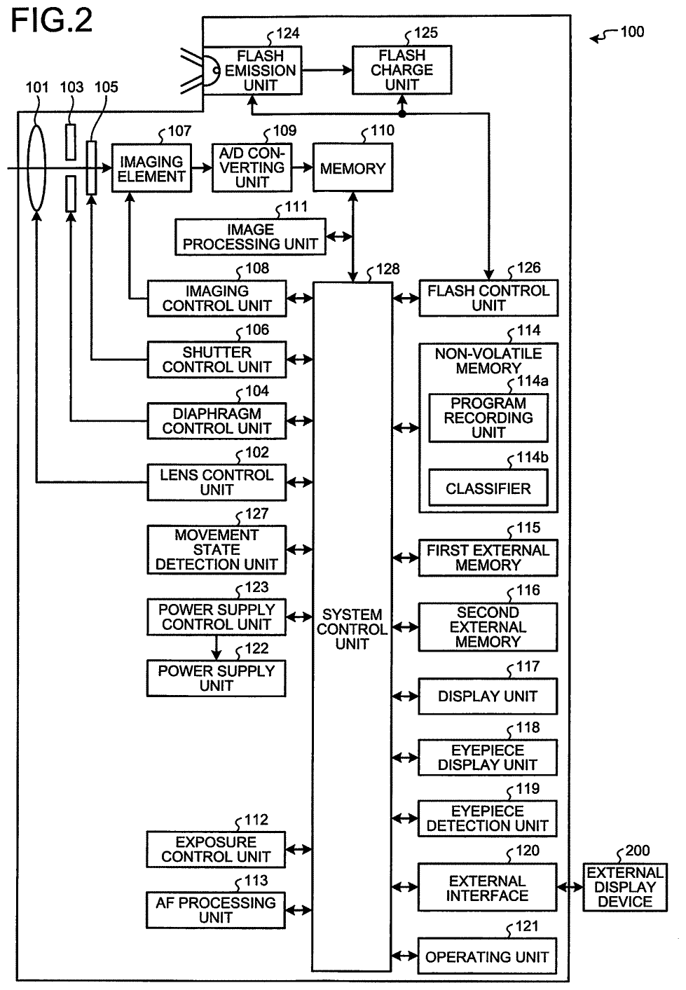

FIG. 1 is a perspective view illustrating a schematic configuration of an image apparatus according to a first embodiment. FIG. 2 is a block diagram illustrating a functional configuration of the image apparatus according to the first embodiment. An image apparatus 100 illustrated in FIG. 1 and FIG. 2 generates image data by capturing an image of an object.

The image apparatus 100 includes an optical system 101, a lens control unit 102, a diaphragm 103, a diaphragm control unit 104, a shutter 105, a shutter control unit 106, an imaging element 107, an imaging control unit 108, an analog-to-digital (A/D) converting unit 109, a memory 110, an image processing unit 111, an exposure control unit 112, an autofocus (AF) processing unit 113, a non-volatile memory 114, a first external memory 115, a second external memory 116, a display unit 117, an eyepiece display unit 118, an eyepiece detection unit 119, an external interface 120, an operating unit 121, a power supply unit 122, a power supply control unit 123, a flash emission unit 124, a flash charge unit 125, a flash control unit 126, and a system control unit 128.

The optical system 101 forms an object image on a light receiving surface of the imaging element 107. The optical system 101 is constructed with one or a plurality of lenses and a driving unit, such as a stepping motor or a voice coil motor, which moves the lenses along an optical axis direction. The optical system 101 moves along the optical axis direction to change a point of focus and a focal distance (angle of view) under the control of the lens control unit 102. Meanwhile, while the optical system 101 is integrated with the image apparatus 100 in FIG. 1, the optical system 101 may be removably mounted on the image apparatus 100 or may be connectable to the image apparatus 100 by wireless communication, for example. Further, it may be possible to dispose a focus ring for adjusting a point of focus, a zoom ring for changing a focal distance, a function button capable of assigning a function of predetermined operation, and the like on an outer peripheral side of the optical system 101.

The lens control unit 102 is constructed with a driving driver or a control circuit that applies a voltage to the optical system 101. The lens control unit 102 changes the point of focus and the angle of view of the optical system 101 by moving the optical system 101 in the optical axis direction by applying a voltage to the optical system 101 under the control of the system control unit 128.

The diaphragm 103 adjusts exposure by controlling the amount of incident light collected by the optical system 101 under the control of the diaphragm control unit 104.

The diaphragm control unit 104 is constructed with a driving driver or a control circuit that applies a voltage to the diaphragm 103. The diaphragm control unit 104 controls an F-number of the diaphragm 103 by applying a voltage to the diaphragm 103 under the control of the system control unit 128.

The shutter 105 changes a state of the imaging element 107 to an exposed stated or a light shielding state under the control of the shutter control unit 106. The shutter 105 is constructed with, for example, a focal-plane shutter, a driving motor, and the like.

The shutter control unit 106 is constructed with a driving driver or a control circuit that applies a voltage to the shutter 105. The shutter control unit 106 drives the shutter 105 by applying a voltage to the shutter 105 under the control of the system control unit 128.

The imaging element 107 receives light of the object image collected by the optical system 101, performs photoelectric conversion to generate image data (RAW data), and outputs the image data to the A/D converting unit 109 under the control of the imaging control unit 108. The imaging element 107 is constructed with an image sensor, such as a charge coupled device (CCD) or a complementary metal oxide semiconductor (CMOS). Meanwhile, it may be possible to use, as pixels of the imaging element 107, phase difference pixels that are used for AF detection.

The imaging control unit 108 is constructed with a timing generator or the like that controls an imaging timing of the imaging element 107. The imaging control unit 108 causes the imaging element 107 to capture an image at a predetermined timing.

The A/D converting unit 109 performs A/D conversion on analog image data input from the imaging element 107 to convert the analog image data into digital image data, and outputs the digital image data to the memory 110. The A/D converting unit 109 is constructed with, for example, an A/D conversion circuit or the like.

The memory 110 is constructed with a frame memory or a buffer memory, such as a video random access memory (VRAM) or a dynamic random access memory (DRAM). The memory 110 temporarily records therein image data that is input from the A/D converting unit 109 and image data that is subjected to image processing by the image processing unit 111, and outputs the recorded image data to the image processing unit 111 or the system control unit 128.

The image processing unit 111 is constructed with a graphics processing unit (GPU) or a field programmable gate array (FPGA). The image processing unit 111 acquires the image data recorded in the memory 110, performs image processing on the acquired image data, and outputs the image data to the memory 110 or the system control unit 128 under the control of the system control unit 128. Here, examples of the image processing include a demosaicing process, a gain-up process, a white balance adjustment process, a noise reduction process, and a developing process for generating Joint Photographic Experts Group (JPEG) data.

The exposure control unit 112 controls exposure of the image apparatus 100 based on image data input via the system control unit 128. Specifically, the exposure control unit 112 outputs a control parameter for adjusting the exposure of the image apparatus 100 to appropriate exposure to the diaphragm control unit 104 and the shutter control unit 106 via the system control unit 128.

The AF processing unit 113 controls the point of focus of the image apparatus 100 based on image data input via the system control unit 128. The AF processing unit 113 outputs a control parameter related to the point of focus of the image apparatus 100 to the lens control unit 102 via the system control unit 128 by using any one of a phase difference system, a contrast system, and a hybrid system in which the phase difference system and the contrast system are combined.

The non-volatile memory 114 records therein various kinds of information and programs related to the image apparatus 100. The non-volatile memory 114 includes a program recording unit 114a for recording a plurality of programs to be executed by the image apparatus 100, and a classifier 114b. The classifier 114b records therein a learning result obtained by learning types of objects using a plurality of pieces of image data, a template used to distinguish the types of the objects, feature data used to distinguish the types of the objects, and the like.

The first external memory 115 is removably attached from the outside of the image apparatus 100. The first external memory 115 records therein an image file including image data (RAW data, JPEG data, or the like) input from the system control unit 128. The first external memory 115 is constructed with a recording medium, such as a memory card.

The second external memory 116 is removably attached from the outside of the image apparatus 100. The second external memory 116 records therein an image file including the image data input from the system control unit 128. The second external memory 116 is constructed with a recording medium, such as a memory card.

The display unit 117 displays an image corresponding to the image data input from the system control unit 128 and various kinds of information on the image apparatus 100. The display unit 117 is constructed with a display panel made of liquid crystal or organic electro luminescence (EL), and a driver, for example.

The eyepiece display unit 118 functions as an electronic viewfinder (EVF), and displays an image corresponding to the image data input from the system control unit 128 and various kinds of information on the image apparatus 100. The eyepiece display unit 118 is constructed with a display panel made of liquid crystal or organic EL, and an eyepiece, for example.

The eyepiece detection unit 119 is constructed with an infrared sensor, an eye sensor, or the like. The eyepiece detection unit 119 detects an object or a user approaching the eyepiece display unit 118, and outputs a detection result to the system control unit 128. The eyepiece detection unit 119 is disposed near the eyepiece display unit 118.

The external interface 120 outputs the image data input from the system control unit 128 to an external display device 200 in accordance with a predetermined communication standard.

The operating unit 121 is constructed with a plurality of operating members and a touch panel. For example, the operating unit 121 is constructed with any of a switch, a button, a joystick, a dial switch, a lever switch, and a touch panel. The operating unit 121 receives input of operation performed by a user, and outputs a signal corresponding to the received operation to the system control unit 128.

As illustrated in FIG. 1, the operating unit 121 includes a shutter button 121a, an imaging dial 121b, an INFO button 121c, a replay button 121d, a cancel button 121e, a MENU button 121f, a selection button 121g, and a determination button 121h.

The shutter button 121a receives input of an instruction signal for giving an instruction on imaging preparation when being pressed halfway, and receives input of an instruction signal for giving an instruction on imaging when being fully pressed.

The imaging dial 121b is rotatable, and receives input of an instruction signal for changing an imaging parameter that is set in the imaging condition. Meanwhile, in the first embodiment, the shutter button 121a functions as a first operating unit.

The INFO button 121c receives input of an instruction signal for causing the display unit 117 or the eyepiece display unit 118 to display information on the image apparatus 100.

The replay button 121d receives input of an instruction signal for giving an instruction on replay of the image data recorded in the first external memory 115 or the second external memory 116.

The cancel button 121e receives input of an instruction signal for giving an instruction on deletion of the image data recorded in the first external memory 115 or the second external memory 116. Further, the cancel button 121e receives input of an instruction signal for giving an instruction on cancellation of settings of the image apparatus 100. Meanwhile, in the first embodiment, the cancel button 121e functions as a second operating unit.

The MENU button 121f is for causing the display unit 117 or the eyepiece display unit 118 to display a menu of the image apparatus 100.

The selection button 121g receives input of an instruction signal for moving a cursor in a vertical direction and a horizontal direction.

The determination button 121h receives input of an instruction signal for determining a selected item.

A touch panel 121i is disposed in a display area of the display unit 117 in a superimposed manner, and receives input of an instruction signal corresponding to a touch position that is externally touched by an object.

The power supply unit 122 is removably mounted on the image apparatus 100. The power supply unit 122 supplies a predetermined voltage to each of the components included in the image apparatus 100 under the control of the power supply control unit 123. The power supply unit 122 is constructed with, for example, a lithium ion rechargeable battery, a nickel-hydride rechargeable battery, or the like.

The power supply control unit 123 adjusts a voltage supplied by the power supply unit 122 to a predetermined voltage under the control of the system control unit 128. The power supply control unit 123 is constructed with a regulator or the like.

The flash emission unit 124 emits light toward an imaging area of the image apparatus 100 under the control of the flash control unit 126. The flash emission unit 124 is constructed with, for example, a light emitting diode (LED) lamp or the like.

The flash charge unit 125 charges power that allows the flash emission unit 124 to emit light.

The flash control unit 126 causes the flash emission unit 124 to emit light at a predetermined timing under the control of the system control unit 128.

A moving state detection unit 127 detects a moving state of the image apparatus 100, and outputs a detection result to the system control unit 128. Specifically, the moving state detection unit 127 detects whether a visual field area of the image apparatus 100 is changed. For example, the moving state detection unit 127 detects a change of acceleration or a posture that occurs due to pan operation performed by a user to detect whether the visual field area of the image apparatus 100 is in a moving state, and outputs a detection result to the system control unit 128. The moving state detection unit 127 is constructed with an acceleration sensor, a gyroscope sensor, or the like. Meanwhile, the moving state detection unit 127 may determine whether the visual field area of the image apparatus 100 is moving by using, for example, a global positioning system (GPS) sensor that acquires positional information from the GPS, or the like. It is of course possible for the moving state detection unit 127 to acquire pieces of temporally consecutive image data from the memory 110, and determine whether the visual field area of the image apparatus 100 is moving based on a change rate of feature data of the pieces of acquired image data.

The system control unit 128 comprehensively controls each of the components included in the image apparatus 100. The system control unit 128 is constructed with a memory and a processor including hardware, such as a central processing unit (CPU), an application specific integrated circuit (ASIC), and a digital signal processor (DSP).

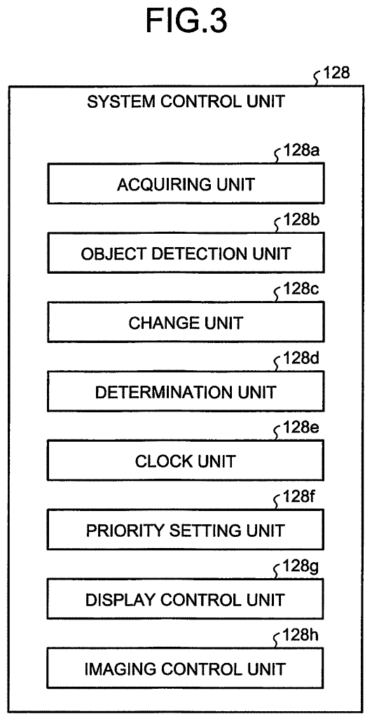

A detailed configuration of the system control unit 128 will be described below. FIG. 3 is a block diagram illustrating a functional configuration of the system control unit 128. The system control unit 128 illustrated in FIG. 3 includes an acquiring unit 128a, an object detection unit 128b, a change unit 128c, a determination unit 128d, a clock unit 128e, a priority setting unit 128f, a display control unit 128g, and an imaging control unit 128h. The system control unit 128 functions as an object detection apparatus according to the first embodiment. Further, it may be possible to assign a function as the object detection apparatus according to the first embodiment to the image processing unit 111, or it may be possible to separately provide a dedicated processor.

The acquiring unit 128a sequentially acquires pieces of image data, which are sequentially generated by the imaging element 107, via the memory 110. The acquiring unit 128a may acquire the pieces of image data from the first external memory 115 or the second external memory 116.

The object detection unit 128b detects a plurality of objects that appear in an image corresponding to image data every time the acquiring unit 128a acquires image data. Specifically, the object detection unit 128b detects a plurality of objects and feature portions in the image by using the learning result, which is obtained by learning types of objects and recorded in the classifier 114b, or by using a predetermined template matching technique. The object detection unit 128b is able to automatically detect, as objects, animals (dogs, cats, etc.), flowers, vehicles (including taillight, headlight, etc.), motorbikes (helmets), trains (driver seats, destination display, and text), airplanes (cockpits), a moon, buildings, and the like, in addition to humans (persons, faces, noses, eyes) by using, for example, a learning result that is obtained by machine learning or learning based on a deep learning technique.

The change unit 128c changes a priority of each of the objects detected by the object detection unit 128b, based on a detection result detected by the object detection unit 128b.

The determination unit 128d determines whether the object detection unit 128b has detected an object with a high priority, every time the acquiring unit 128a acquires image data.

The clock unit 128e has a clock function and a timer function, and generates time information to be added to image data generated by the image apparatus 100, or time information for operating each of the components included in the image apparatus 100.

The priority setting unit 128f sets a priority of each of the objects in accordance with operation on the operating unit 121.

The display control unit 128g controls a display mode of the display unit 117 or the eyepiece display unit 118. Specifically, the display control unit 128g causes the display unit 117 or the eyepiece display unit 118 to display an image corresponding to image data and information (a character code or a frame) representing various states of an apparatus.

The imaging control unit 128h controls imaging performed by the image apparatus 100. Specifically, the imaging control unit 128h changes an imaging parameter used at the time of imaging, based on an object with a high priority. For example, the imaging control unit 128h performs AF processing for adjusting the point of focus of the image apparatus 100 to an object with the highest priority.

Operation Process of Image Apparatus

Next, an outline of an operation process performed by the image apparatus 100 will be described.

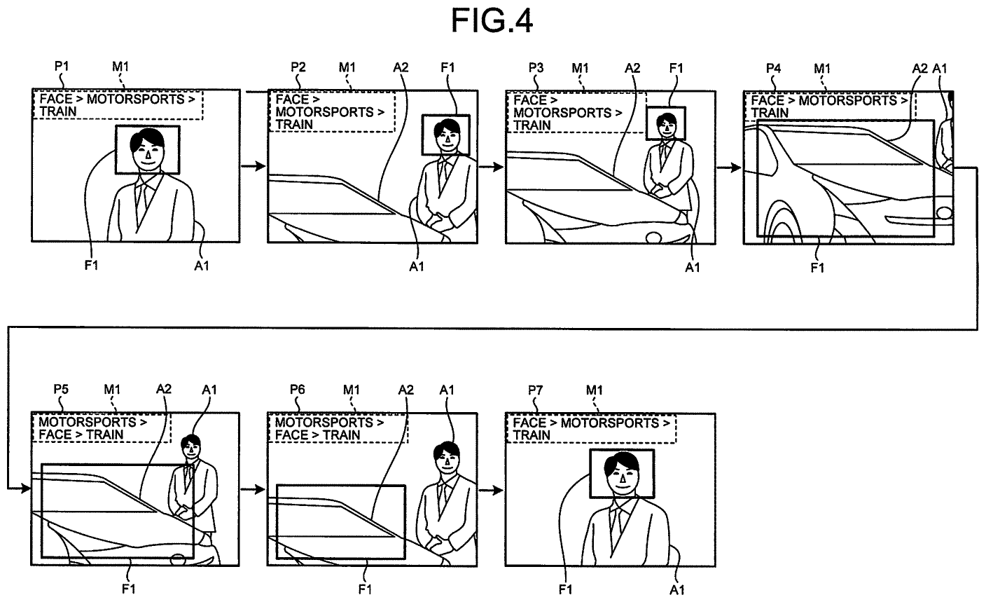

FIG. 4 is a schematic diagram for explaining an outline of the operation process performed by the image apparatus 100. Further, in FIG. 4, a case will be described in which only a face, a vehicle (motorsports), and a train are adopted as objects for simplicity of explanation. Meanwhile, in FIG. 4, a case will be described in which the priority setting unit 128f assigns priorities of the objects to the face, the motorsports, and the train in this order from the highest to the lowest (face>motorsports>train) in accordance with operation on the operating unit 121 before imaging. Furthermore, in the following, a case will be described in which a user performs imaging while viewing the eyepiece display unit 118, but the same applies to a case in which a user performs imaging using the display unit 117 or the external display device 200 (for example, it is assumed that tether imaging is performed). Moreover, while three priorities are set in. FIG. 4, embodiments are not limited to this example, and the number of priorities may be appropriately changed, for example, may be four or two.

As illustrated in FIG. 4, first, the object detection unit 128b detects a face of an object A1 that appears in an image P1. In this case, the display control unit 128g causes the eyepiece display unit 118 to display, in a superimposed manner, a detection frame F1 in an area including the face of the object A1 on the image P1. Further, the display control unit 128g causes the eyepiece display unit 118 to display, in a superimposed manner, priority information M1 related to the current priorities of the objects on the image P1. Therefore, the user is able to intuitively recognize the current priorities and intuitively recognize a current main object.

Subsequently, in an image P2 and an image P3 that are sequentially generated by the image apparatus 100 (the image P1→the image P2→the image P3), an object A2 (second priority), i.e., a vehicle (motorsports), appears in addition to the object A1 in accordance with user operation of changing composition or the angle of view of the imaging area of the image apparatus 100. In this case, the object detection unit 128b detects the object A1 and the object A2 from each of the image P2 and the image P3. In this case, even when the object detection unit 128b detects the object A2, because the object detection unit 128b also detects the object A1 (first priority), the change unit 128c maintains the priorities of the objects without changing the priorities of the objects (face>motorsports>train). Therefore, the display control unit 128g causes the eyepiece display unit 118 to display, in a superimposed manner, the detection frame F1 in an area including the face of the object A1 on each of the image P2 and the image P3.

Thereafter, in an image P4 generated by the image apparatus 100, only the object A2 (second priority) appears in accordance with user operation of changing the composition or the angle of view of the imaging area of the image apparatus 100. In this case, the object detection unit 128b detects the object A2 (second priority) but does not detect the object A1 (first priority) from the image P4. Therefore, the determination unit 128d determines that the object detection unit 128b has not detected the object A1 with the high priority, so that the change unit 128c increases the priority of the object A2 (second priority) detected by the object detection unit 128b. Specifically, the change unit 128c changes the priority of the object A2 to the first priority and changes the priority of the object A1 to the second priority (motorsports>face>train). In this case, the display control unit 128g causes the eyepiece display unit 118 to display, in a superimposed manner, the detection frame F1 in an area including the object A2 detected by the object detection unit 128b on the image P4.

Subsequently, in an image P5 and an image P6 generated by the image apparatus 100 (the image P4→the image P5→the image P6), the object A2 (first priority) and the object A1 (second priority) appear in accordance with user operation of changing the composition or the angle of view of the imaging area of the image apparatus 100. In this case, the object detection unit 128b detects the object A2 (first priority) and the object A1 (second priority) from each of the image P5 and the image P6. In this case, because the change unit 128c has changed the priorities of the objects (motorsports>face>train), the display control unit 128g causes the eyepiece display unit 118 to display, in a superimposed manner, the detection frame F1 in an area including the object A2 detected by the object detection unit 128b on each of the image P5 and the image P6. Consequently, the user is able to intuitively recognize the current priorities.

Thereafter, in an image P7 generated by the image apparatus 100, only the object A1 (second priority) appears in accordance with user operation of changing the composition or the angle of view of the imaging area of the image apparatus 100. In this case, the object detection unit 128b detects the object A1 (second priority) but does not detect the object A2 (first priority) from the image P7. Therefore, the determination unit 128d determines that the object detection unit 128b has not detected the object A2 with the high priority, so that the change unit 128c increases the priority of the object A1 (second priority) detected by the object detection unit 128b. Specifically, the change unit 128c changes the priority of the object A1 to the first priority and changes the priority of the object A2 to the second priority (face>motorsports>train). In this case, the display control unit 128g causes the eyepiece display unit 118 to display, in a superimposed manner, the detection frame F1 in an area including the object A1 detected by the object detection unit 128b on the image P7. Further, the display control unit 128g causes the eyepiece display unit 118 to display, in a superimposed manner, the priority information M1 related to the current priorities of the objects on the image P7.

Process Performed by Image Apparatus

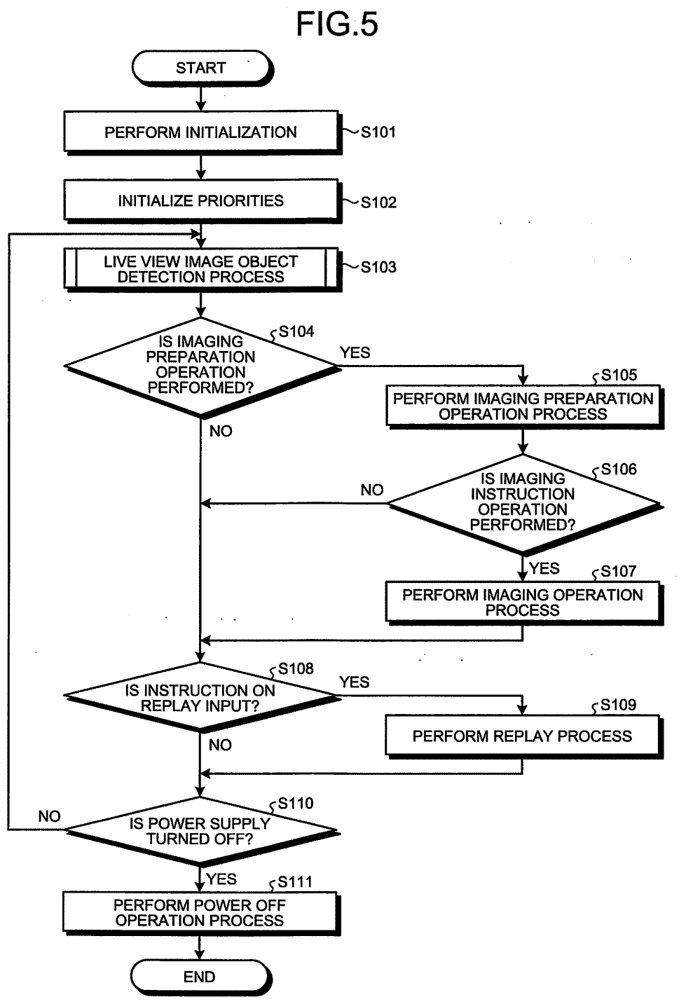

Next, a process performed by the image apparatus 100 will be described. FIG. 5 is a flowchart illustrating an outline of the process performed by the image apparatus 100.

As illustrated in FIG. 5, first, when a power supply of the image apparatus 100 is turned on, the system control unit 128 initializes the image apparatus 100 (Step S101).

Subsequently, the priority setting unit 128f initializes priorities that are adopted when the imaging parameter used for imaging is changed (Step S102). Specifically, the priority setting unit 128f initializes the priorities of the objects that are used for adjusting the imaging parameter when the imaging element 107 performs imaging. For example, the priority setting unit 128f assigns priorities of AF targets to be adopted by the image apparatus 100 to the face, the motorsports, and the train in this order from the highest to the lowest (face>motorsports>train).

Thereafter, the image apparatus 100 performs a live view image object detection process for detecting objects in live view images corresponding to pieces of image data that are sequentially generated by the imaging element 107 (Step S103). Meanwhile, the live view image object detection process will be described in detail later. After Step S103, the image apparatus 100 proceeds to Step S104 to be described below.

Thereafter, if imaging preparation operation is performed on the operating unit 121 (Step S104: Yes), the image apparatus 100 proceeds to Step S105 to be described later. Here, the imaging preparation operation is operation of receiving, from the shutter button 121a, input of an instruction signal (first release signal) for giving an instruction to prepare for imaging when the shutter button 121a is pressed halfway. In contrast, if the imaging preparation operation is not performed on the operating unit 121 (Step S104: No), the image apparatus 100 proceeds to Step S108 to be described later.

At Step S105, the image apparatus 100 performs the imaging preparation operation. Specifically, the imaging control unit 128h causes the AF processing unit 113 to perform AF processing to adjust the point of focus of the image apparatus 100 to an object with the highest priority, and causes the exposure control unit 112 to perform AE processing to set appropriate exposure with reference to the object with the highest priority.

Subsequently, if imaging instruction operation is performed on the operating unit 121 (Step S106: Yes), the imaging control unit 128h causes the imaging element 107 to perform imaging operation (Step S107). Here, the imaging instruction operation is operation of receiving, from the shutter button 121a, input of an instruction signal (second release signal) for giving an instruction on imaging when the shutter button 121a is fully pressed, or operation of receiving input of an instruction signal for giving an instruction on imaging when the touch panel 121i is touched. Further, the imaging operation is a process of causing the imaging element 107 to generate image data. Meanwhile, in the imaging operation, it may be possible to cause the image processing unit 111 to perform image processing on image data in accordance with settings of the image apparatus 100 and store the image data in the first external memory 115 and the second external memory 116, or it may be possible to simply store image data in the first external memory 115 and the second external memory 116. After Step S107, the image apparatus 100 proceeds to Step S108 to be described later.

At Step S106, if the imaging instruction operation is not performed on the operating unit 121 (Step S106: No), the image apparatus 100 proceeds to Step S108 to be described below.

At Step S108, if an instruction signal for giving an instruction on replay of image data is input from the operating unit 121 (Step S108: Yes), the image apparatus 100 performs a replay process for causing the display unit 117 or the eyepiece display unit 118 to replay an image corresponding to image data recorded in the first external memory 115 or the second external memory 116 (Step S109). After Step S109, the image apparatus 100 proceeds to Step S110 to be described later.

At Step S108, if the instruction signal for giving an instruction on replay of image data is not input from the operating unit 121 (Step S108: No), the image apparatus 100 proceeds to Step S110 to be described below.

At Step S110, if the power supply of the image apparatus 100 is turned off by operation on the operating unit 121 (Step S110: Yes), the image apparatus 100 performs a power off operation process for recording various settings in the non-volatile memory 114 (Step S111). After Step S110, the image apparatus 100 terminates the process. In contrast, if the power supply of the image apparatus 100 is not turned off by operation on the operating unit 121 (Step S110: No), the image apparatus 100 returns to Step S103 described above.

Live View Image Object Detection Process

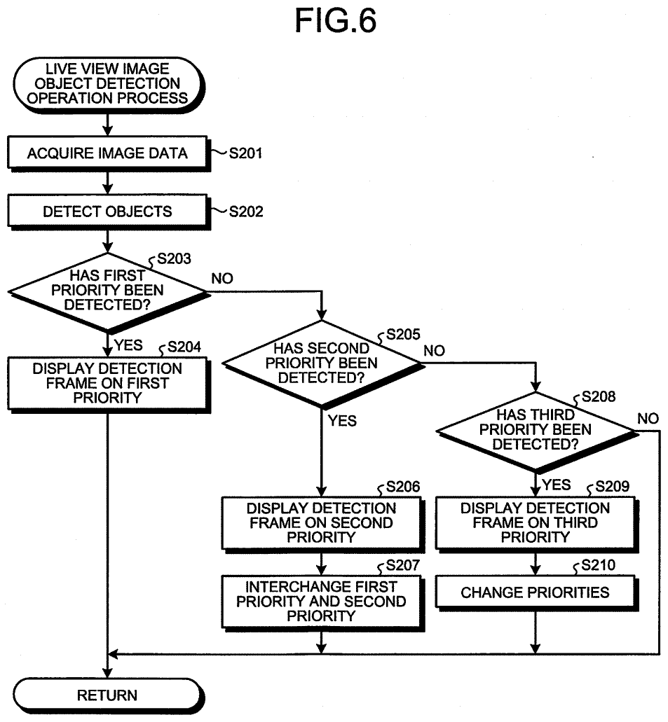

Next, the live view image object detection process in FIG. 5 described above will be described in detail below. FIG. 6 is a flowchart illustrating an outline of the live view image object detection process in FIG. 5.

As illustrated in FIG. 6, first, the acquiring unit 128a acquires image data from the memory 110 (Step S201).

Subsequently, the object detection unit 128b detects a plurality of objects as a plurality of feature portions in an image corresponding to the image data acquired by the acquiring unit 128a, by using the learning result recorded in the classifier 114b or a well-known pattern matching technique (Step S202).

Thereafter, the determination unit 128d determines whether the object detection unit 128b has detected an object with the first priority in the image (Step S203). If the determination unit 128d determines that the object detection unit 128b has detected the object with the first priority in the image (Step S203: Yes), the image apparatus 100 proceeds to Step S204 to be described later. In contrast, if the determination unit 128d determines that the object detection unit 128b has not detected the object with the first priority in the image (Step S203: No), the image apparatus 100 proceeds to Step S205 to be described later.

At Step S204, the display control unit 128g causes the eyepiece display unit 118 to display, in a superimposed manner, the detection frame F1 in an area including the object with the first priority detected by the object detection unit 128b on the image. In this case, the display control unit 128g may cause the eyepiece display unit 118 to display, in a superimposed manner, the priority information M1 related to the current priorities of the objects on the image. After Step S204, the image apparatus 100 returns to the main routine of FIG. 5.

At Step S205, the determination unit 128d determines whether the object detection unit 128b has detected an object with the second priority in the image. If the determination unit 128d determines that the object detection unit 128b has detected an object with the second priority in the image (Step S205: Yes), the image apparatus 100 proceeds to Step S206 to be described later. In contrast, if the determination unit 128d determines that the object detection unit 128b has not detected an object with the second priority in the image (Step S205: No), the image apparatus 100 proceeds to Step S208 to be described later.

At Step S206, the display control unit 128g causes the eyepiece display unit 118 to display, in a superimposed manner, the detection frame F1 in an area including the object with the second priority detected by the object detection unit 128b on the image.

Subsequently, the change unit 128c changes the priority of the object with the second priority detected by the object detection unit 128b to the first priority, and changes the priority of the object with the first priority to the second priority (Step S207). After Step S207, the image apparatus 100 returns to the main routine of FIG. 5.

At Step S208, the determination unit 128d determines whether the object detection unit 128b has detected an object with the third priority in the image. If the determination unit 128d determines that the object detection unit 128b has detected an object with the third priority in the image (Step S208: Yes), the image apparatus 100 proceeds to Step S209 to be described later. In contrast, if the determination unit 128d determines that the object detection unit 128b has not detected an object with the third priority in the image (Step S208: No), the image apparatus 100 returns to the main routine of FIG. 5.

At Step S209, the display control unit 128g causes the eyepiece display unit 118 to display, in a superimposed manner, the detection frame F1 in an area including the object with the third priority detected by the object detection unit 128b on the image.

Subsequently, the change unit 128c changes the priority of the object with the third priority detected by the object detection unit 128b to the first priority, changes the priority of the object with the first priority to the second priority, and changes the priority of the object with the second priority to the third priority (Step S210). After Step S210, the image apparatus 100 returns to the main routine of FIG. 5.

According to the first embodiment as described above, the change unit 128c changes the priorities of a plurality of objects based on a detection result obtained by the object detection unit 128b, so that even when the number of objects to be detected is increased, it is possible to immediately change the priorities.

Furthermore, according to the first embodiment, the determination unit 128d determines whether the object detection unit 128b has detected an object with a high priority every time the acquiring unit 128a acquires image data, and the change unit 128c changes priorities of a plurality of objects based on a determination result obtained by the determination unit 128d, so that it is possible to automatically change the priorities.

Moreover, according to the first embodiment, when the determination unit 128d determines that the object detection unit 128b has not detected an object with a high priority, the change unit 128c increases a priority of an object detected by the object detection unit 128b, so that it is possible to automatically change the priorities.

Furthermore, according to the first embodiment, the display control unit 128g causes the display unit 117 or the eyepiece display unit 118 to display, in a superimposed manner, a detection frame in an area including an object with the highest priority detected by the object detection unit 128b on the image, so that it is possible to intuitively recognize the object with the highest priority in real time.

Moreover, according to the first embodiment, the display control unit 128g causes the display unit 117 or the eyepiece display unit 118 to display, in a superimposed manner, information related to priorities on the image, so that it is possible to intuitively recognize the priority of each of the objects in real time.

### Second Embodiment

Next, a second embodiment will be described. An image apparatus according to the second embodiment has the same configuration as the image apparatus 100 according to the first embodiment as described above, but performs a different operation process and a different live view image object detection process. Specifically, in the first embodiment as described above, the change unit 128c changes priorities of objects every time the acquiring unit 128a acquires image data; however, the image apparatus according to the second embodiment changes priorities when an object with a high priority is not detected in a predetermined time. In the following, an operation process and a live view image object detection process performed by the image apparatus according to the second embodiment will be described. The same components as those of the image apparatus 100 according to the first embodiment described above are denoted by the same reference signs, and detailed explanation thereof will be omitted.

Operation Process of Image Apparatus

First, an outline of an operation process performed by the image apparatus 100 will be described.

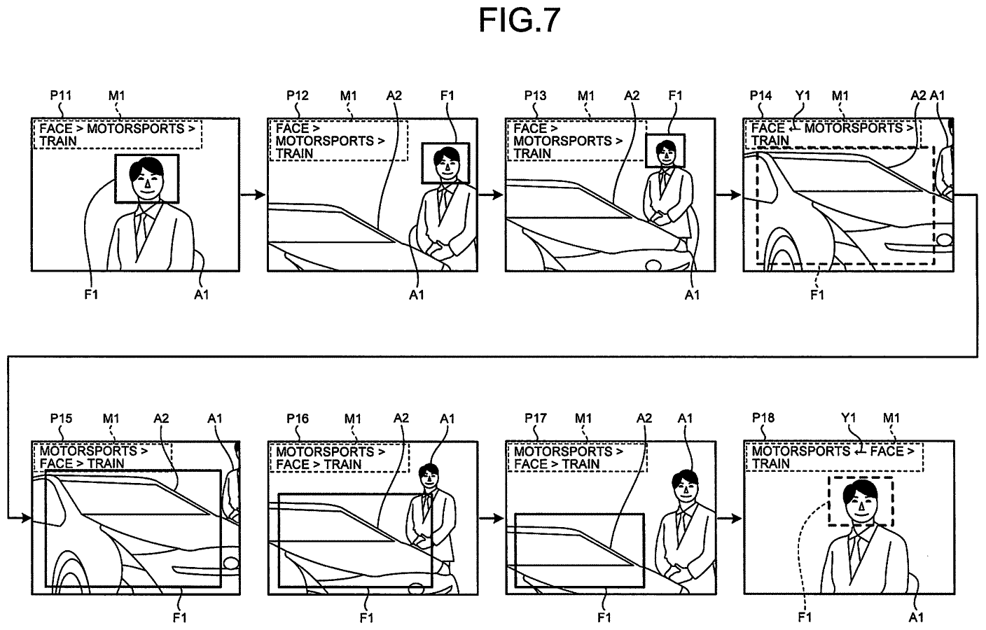

FIG. 7 is a schematic diagram for explaining the outline of the operation process performed by the image apparatus 100. In FIG. 7, similarly to the first embodiment as described above, a case will be described in which only a face, a vehicle (motorsports), and a train are adopted as objects for simplicity of explanation. Meanwhile, in FIG. 7, a case will be described in which the priority setting unit 128f assigns priorities of the objects to the face, the motorsports, and the train in this order from the highest to the lowest (face>motorsports>train) in accordance with operation on the operating unit 121 before imaging. Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 7, embodiments are not limited to this example, and the number of priorities may be appropriately changed.

As illustrated in FIG. 7, first, the object detection unit 128b detects the face of the object A1 that appears in an image P11. In this case, the display control unit 128g causes the eyepiece display unit 118 to display, in a superimposed manner, the detection frame F1 in an area including the face of the object A1 on the image P11. Further, the display control unit 128g causes the eyepiece display unit 118 to display, in a superimposed manner, the priority information M1 related to the current priorities of the objects on the image P11.

Subsequently, in an image P12 and an image P13 that are sequentially generated by the image apparatus 100 (the image P11→the image P12→the image P13), the object A2 (second priority), i.e., a vehicle (motorsports), appears in addition to the object A1 in accordance with user operation of changing the composition or the angle of view of the imaging area of the image apparatus 100. In this case, the object detection unit 128b detects the object A1 and the object A2 from each of the image P12 and the image P13. In this case, even when the object detection unit 128b detects the object A2, because the object detection unit 128b also detects the object A1 (first priority), the change unit 128c maintains the priorities of the objects without changing the priorities of the objects (face>motorsports>train). Therefore, the display control unit 128g causes the eyepiece display unit 118 to display, in a superimposed manner, the detection frame F1 in an area including the face of the object A1 on each of the image P12 and the image P13.

Thereafter, in an image P14 generated by the image apparatus 100, only the object A2 (second priority) appears in accordance with user operation of changing the composition or the angle of view of the imaging area of the image apparatus 100. In this case, the object detection unit 128b detects the object A2 (second priority) but does not detect the object A1 (first priority) from the image P14. In this case, the display control unit 128g causes the eyepiece display unit 118 to display the detection frame F1 in an area including the object A2 detected by the object detection unit 128b on the image P14 in a highlighted manner by blinking or highlighting. Further, the display control unit 128g causes the eyepiece display unit 118 to display a warning Y1, which indicates that the priorities are to be changed, in the priority information M1 in a superimposed manner. Therefore, the user is able to intuitively recognize that the priorities are to be changed. Furthermore, the determination unit 128d counts times from when the object detection unit 128b fails to detect the object A1, based on time information input from the clock unit 128e. Meanwhile, the determination unit 128d may count times based on the number of frames of image data generated by the imaging element 107, instead of based on the time information.

Subsequently, in an image P15 generated by the image apparatus 100, only the object A2 (second priority) appears because the user maintains the composition of the imaging area of the image apparatus 100. In this case, the object detection unit 128b detects the object A2 (second priority) but does not detect the object A1 (first priority) from the image P15. In this case, the determination unit 128d determines whether a predetermined time (for example, 3 seconds) has elapsed from the time when the object detection unit 128b fails to detect the object A1, based on the time information input from the clock unit 128e. Then, if the determination unit 128d determines that the predetermined time has elapsed, the display control unit 128g causes the eyepiece display unit 118 to display, in a superimposed manner, the detection frame F1 in an area including the object A2 detected by the object detection unit 128b on the image P15. In this case, the determination unit 128d determines that the object detection unit 128b has not detected the object A1 with a high priority in the predetermined time, so that the change unit 128c increases the priority of the object A2 (second priority) detected by the object detection unit 128b. Specifically, the change unit 128c changes the priority of the object A2 to the first priority, and changes the priority of the object A1 to the second priority (motorsports>face>train). Meanwhile, the time to be determined by the determination unit 128d may be appropriately changed in accordance with operation on the operating unit 121.

Thereafter, in an image P16 and an image P17 generated by the image apparatus 100 (the image P15→the image P16→the image P17), the object A2 (first priority) and the object A2 (second priority) appear in accordance with user operation of changing the composition or the angle of view of the imaging area of the image apparatus 100. In this case, the object detection unit 128b detects the object A2 (first priority) and the object A1 (first priority) from each of the image P16 and the image P17. In this case, because the change unit 128c has changed the priorities of the objects (motorsports>face>train), the display control unit 128g causes the eyepiece display unit 118 to display, in a superimposed manner, the detection frame F1 in an area including the object A2 detected by the object detection unit 128b on each of the image P16 and the image P17. Consequently, the user is able to intuitively recognize the current priorities.

Thereafter, in an image P18 generated by the image apparatus 100, only the object A1 (second priority) appears in accordance with user operation of changing the composition or the angle of view of the imaging area of the image apparatus 100. In this case, the object detection unit 128b detects the object A1 (second priority) but does not detect the object A2 (first priority) from the image P18. In this case, the display control unit 128g causes the eyepiece display unit 118 to display the detection frame F1 in an area including the object A1 detected by the object detection unit 128b on the image P18 in a highlighted manner by blinking or highlighting. Further, the display control unit 128g causes the eyepiece display unit 118 to display the warning Y1, which indicates that the priorities are to be changed, in the priority information M1 in a superimposed manner. Therefore, the user is able to intuitively recognize that the priorities are to be changed. Furthermore, the determination unit 128d counts times from when the object detection unit 128b fails to detect the object A2, based on time information input from the clock unit 128e.

Live View Image Object Detection Process

Next, the live view image object detection process performed by the image apparatus 100 will be described.

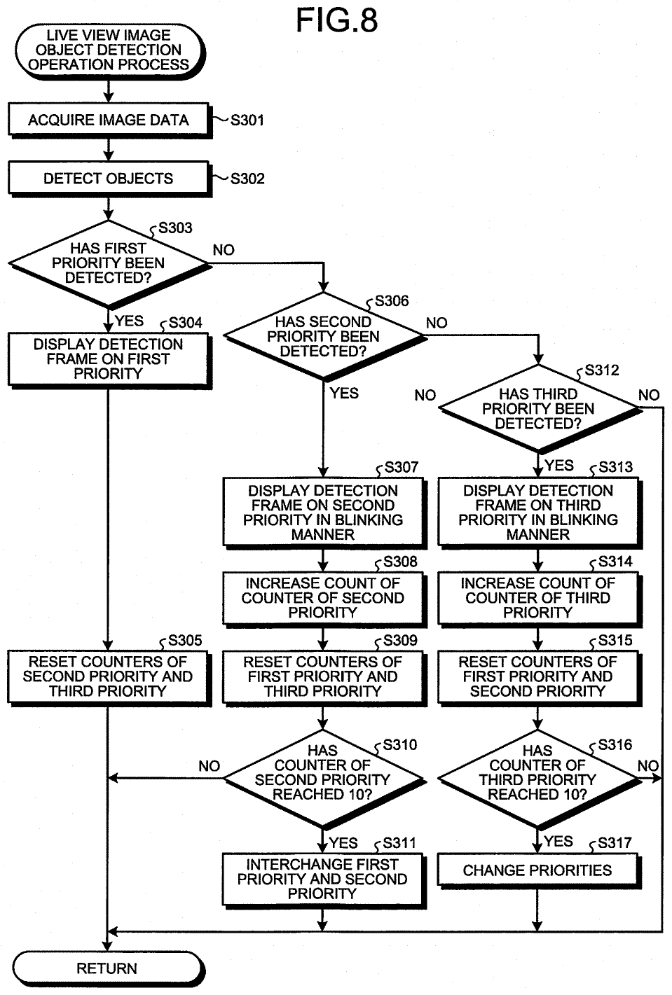

FIG. 8 is a flowchart illustrating an outline of the live view image object detection process performed by the image apparatus 100. In FIG. 8, Step S301 to Step S304 respectively correspond to Step S201 to Step S204 described above.

At Step S305, the determination unit 128d resets counts of the second priority and the third priority detected by the object detection unit 128b, based on the time information input from the clock unit 128e. After Step S305, the image apparatus 100 returns to the main routine of FIG. 5.

At Step S306, the determination unit 128d determines whether the object detection unit 128b has detected an object with the second priority in the image. If the determination unit 128d determines that the object detection unit 128b has detected an object with the second priority in the image (Step S306: Yes), the image apparatus 100 proceeds to Step S307 to be described later. In contrast, if the determination unit 128d determines that the object detection unit 128b has not detected an object with the second priority in the image (Step S306: No), the image apparatus 100 proceeds to Step S312 to be described later.

At Step S307, the display control unit 128g causes the eyepiece display unit 118 to display, in a blinking manner, the detection frame F1 in an area including the object with the second priority detected by the object detection unit 128b.

Subsequently, the determination unit 128d increases a count of the object with the second priority to change the priority to the first priority based on the time information input from the clock unit 128e (Step S308), and resets a count of each of the object with the first priority and the object with the third priority (Step S309).

Thereafter, the determination unit 128d determines whether the count of the object with the second priority has reached a predetermined time (count=10) (Step S310). If the determination unit 128d determines that the count of the object with the second priority has reached the predetermined time (Step S310: Yes), the image apparatus 100 proceeds to Step S311 to be described later. In contrast, if the determination unit 128d determines that the count of the object with the second priority has not reached the predetermined time (Step S310: No), the image apparatus 100 returns to the main routine of FIG. 5.

At Step S311, the change unit 128c changes the priority of the object with the second priority detected by the object detection unit 128b to the first priority, and changes the priority of the object with the first priority to the second priority. After Step S311, the image apparatus 100 returns to the main routine of FIG. 5.

At Step S312, the determination unit 128d determines whether the object detection unit 128b has detected an object with the third priority in the image. If the determination unit 128d determines that the object detection unit 128b has detected an object with the third priority in the image (Step S312: Yes), the image apparatus 100 proceeds to Step S313 to be described later. In contrast, if the determination unit 128d determines that the object detection unit 128b has not detected an object with the third priority in the image (Step S312: No), the image apparatus 100 returns to the main routine of FIG. 5.

At Step S313, the display control unit 128g causes the eyepiece display unit 118 to display, in a blinking manner, the detection frame F1 in an area including the object with the third priority detected by the object detection unit 128b.

Subsequently, the determination unit 128d increases a count of the object with the third priority to change the priority to the first priority, based on the time information input from the clock unit 128e (Step S314), and resets a count of each of the object with the first priority and the object with the second priority (Step S315).

Thereafter, the determination unit 128d determines whether the count of the object with the third priority has reached a predetermined time (count=10) (Step S316). If the determination unit 128d determines that the count of the object with the third priority has reached the predetermined time (Step S316: Yes), the image apparatus 100 proceeds to Step S317 to be described later. In contrast, if the determination unit 128d determines that the count of the object with the third priority has not reached the predetermined time (Step S316: No), the image apparatus 100 returns to the main routine of FIG. 5.

At Step S317, the change unit 128c changes the priority of the object with the third priority detected by the object detection unit 128b to the first priority, changes the priority of the object with the first priority to the second priority, and changes the priority of the object with the second priority to the third priority. After Step S317, the image apparatus 100 returns to the main routine of FIG. 5.

According to the second embodiment as described above, when the determination unit 128d determines that the object detection unit 128b has not detected an object with a high priority in a predetermined time, the change unit 128c changes priorities of a plurality of objects that have been detected by the object detection unit 128b in the predetermined time. Therefore, even when the number of objects to be detected is increased, it is possible to automatically change the priorities, so that a user is able to easily change the priorities by only continuously capturing a specific object within the angle of view or within the finder window.

### Third Embodiment

Next, a third embodiment will be described. An image apparatus according to the third embodiment is different from the image apparatus 100 according to the first embodiment as described above in that a system control unit has a different configuration from the system control unit 128 and the image apparatus performs a different live view image object detection process. Specifically, the image apparatus according to the third embodiment changes priorities when a user continuously captures a desired object in a specific region. In the following, a configuration of the system control unit included in the image apparatus of the third embodiment is first described, and thereafter, the live view image object detection process performed by the image apparatus of the third embodiment will be described. Meanwhile, the same components as those of the image apparatus 100 according to the first embodiment described above are denoted by the same reference signs, and detailed explanation thereof will be omitted.

Configuration of System Control Unit

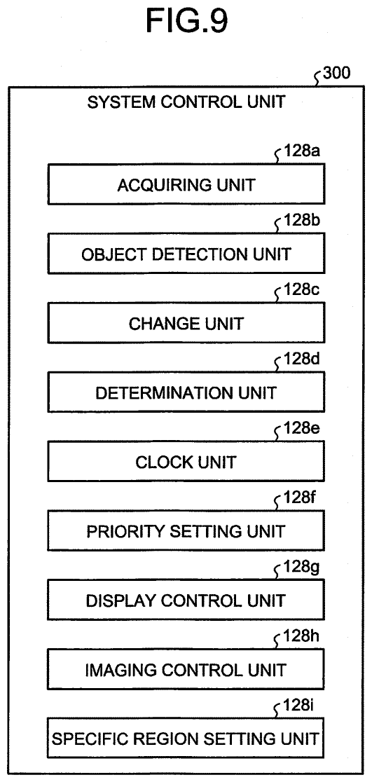

FIG. 9 is a block diagram illustrating a detailed configuration of the system control unit according to the third embodiment. A system control unit 300 illustrated in FIG. 9 includes a specific region setting unit 128i in addition to the components of the system control unit 128 according to the first embodiment as described above.

The specific region setting unit 128i sets a specific region in an image in accordance with operation on the operating unit 121. Specifically, the specific region setting unit 128i sets a specific region such that a main object appears at a composition position desired by a user or a finder position in an EVF (in an image displayed by the eyepiece display unit 118), in accordance with operation on the operating unit 121.

Operation Process of Image Apparatus

Next, an outline of an operation process performed by the image apparatus 100 will be described.

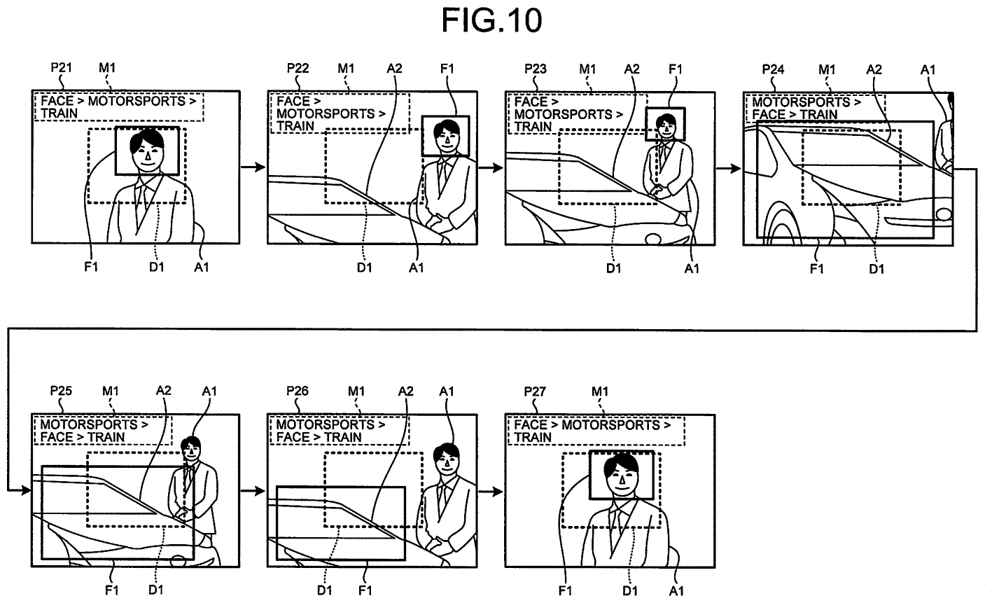

FIG. 10 is a schematic diagram for explaining the outline of the operation process performed by the image apparatus 100. In FIG. 10, similarly to the first embodiment and the second embodiment as described above, a case will be described in which only a face, a vehicle (motorsports), and a train are adopted as objects for simplicity of explanation. Meanwhile, in FIG. 10, a case will be described in which the priority setting unit 128f assigns priorities of the objects to the face, the motorsports, and the train in this order from the highest to the lowest (face>motorsports>train) in accordance with operation on the operating unit 121 before imaging. Further, in FIG. 10, a case will be described in which the specific region setting unit 128i has set the specific region to the center of an image in advance, in accordance with operation on the operating unit 121. Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 10, embodiments are not limited to this example, and the number of priorities may be appropriately changed.

As illustrated in FIG. 10, first, the object detection unit 128b detects the face of the object A1 that appears in an image P21. In this case, the display control unit 128g causes the eyepiece display unit 118 to display, in a superimposed manner, the detection frame F1 in an area including the face of the object A1 on the image P21. Further, the display control unit 128g causes the eyepiece display unit 118 to display, in a superimposed manner, the priority information M1 related to the current priorities of the objects on the image P21. In this case, the determination unit 128d determines whether the object A1 detected by the object detection unit 128b is located in a specific region D1 that has been set by the specific region setting unit 128i.

Subsequently, in an image P22 and an image P23 that are sequentially generated by the image apparatus 100 (the image P21→the image P22→the image P23), the object A2 (second priority), i.e., a vehicle (motorsports), appears in addition to the object A1 in accordance with user operation of changing the composition or the angle of view of the imaging area of the image apparatus 100. In this case, the object detection unit 128b detects the face of the object A1 and the object A2 from each of the image P22 and the image P23. In this case, the determination unit 128d determines whether any one of the object A1 and the object A2 detected by the object detection unit 128b is located in the specific region D1 that has been set by the specific region setting unit 128i. In the image P22 and the image P23, the determination unit 128d determines that the object A1 and the object A2 detected by the object detection unit 128b are not located in the specific region D1 that has been set by the specific region setting unit 128i. Therefore, even when the object detection unit 128b has detected the object A2, the change unit 128c does not change the priorities of the object A1 and the object A2. Further, the display control unit 128g causes the eyepiece display unit 118 to display, in a superimposed manner, the detection frame F1 in an area including the face of the object A1.

Thereafter, in an image P24 generated by the image apparatus 100, only the object A2 (second priority) appears in accordance with user operation of changing the composition or the angle of view of the imaging area of the image apparatus 100. In this case, the object detection unit 128b detects the object A2 (second priority) but does not detect the object A1 (first priority) from the image P24. In this case, the display control unit 128g causes the eyepiece display unit 118 to display, in a superimposed manner, the detection frame F1 in an area including the object A2 detected by the object detection unit 128b on the image P24. Further, the determination unit 128d determines whether the object A2 detected by the object detection unit 128b is located in the specific region D1 that has been detected by the specific region setting unit 128i. In the image P24, the determination unit 128d determines that the object A2 detected by the object detection unit 128b is located in the specific region D1 that has been detected by the specific region setting unit 128i. Therefore, because the determination unit 128d determines that the object detection unit 128b has detected the object A2 in the specific region D1, the change unit 128c increases the priority of the object A2 (second priority) detected by the object detection unit 128b. Specifically, the change unit 128c changes the priority of the object A2 to the first priority, and changes the priority of the object A1 to the second priority (motorsports>face>train). Consequently, it is possible to automatically increase the priority of the object A2 located in the specific region D1 and easily perform imaging such that a main object is arranged in user's desired composition.

Subsequently, in an image P25 and an image P26 that are generated by the image apparatus 100 (the image P24→the image P25→the image P26), the object A1 appears in addition to the object A2 (first priority) in accordance with user operation of changing the composition or the angle of view of the imaging area of the image apparatus 100. In this case, the object detection unit 128b detects the face of the object A1 and the object A2 from each of the image P25 and the image P26. In this case, the determination unit 128d determines whether any one of the object A1 and the object A2 detected by the object detection unit 128b is located in the specific region D1 that has been set by the specific region setting unit 128i. In each of the image P25 and the image P26, the determination unit 128d determines that the object A2 (motorsports) detected by the object detection unit 128b is located in the specific region D1 that has been set by the specific region setting unit 128i. Therefore, even when the object detection unit 128b has detected the object A1, the change unit 128c does not change the priorities of the object A2 (motorsports) and the object A1 (face). Further, the display control unit 128g causes the eyepiece display unit 118 to display, in a superimposed manner, the detection frame F1 in an area including the object A2.

Thereafter, in an image P27 that is generated by the image apparatus 100, only the object A1 (second priority) appears in accordance with user operation of changing the composition or the angle of view of the imaging area of the image apparatus 100. In this case, the object detection unit 128b detects the object A1 (second priority) but does not detect the object A2 (first priority) from the image P27. In this case, the display control unit 128g causes the eyepiece display unit 118 to display the detection frame F1 in an area including the object A1 detected by the object detection unit 128b on the image P27. Further, the determination unit 128d determines whether the object A1 detected by the object detection unit 128b is located in the specific region D1 set by the specific region setting unit 128i. In the image P27, the determination unit 128d determines that the object A1 (face) detected by the object detection unit 128b is located in the specific region D1 that has been set by the specific region setting unit 128i. Therefore, the change unit 128c changes the priority of the object A1 detected by the object detection unit 128b to the first priority, and changes the priority of the object A2 (motorsports) to the second priority. Further, the display control unit 128g causes the eyepiece display unit 118 to display, in a superimposed manner, the detection frame F1 in an area including the object A1.

Live View Image Object Detection Process

Next, the live view image object detection process performed by the image apparatus 100 will be described.

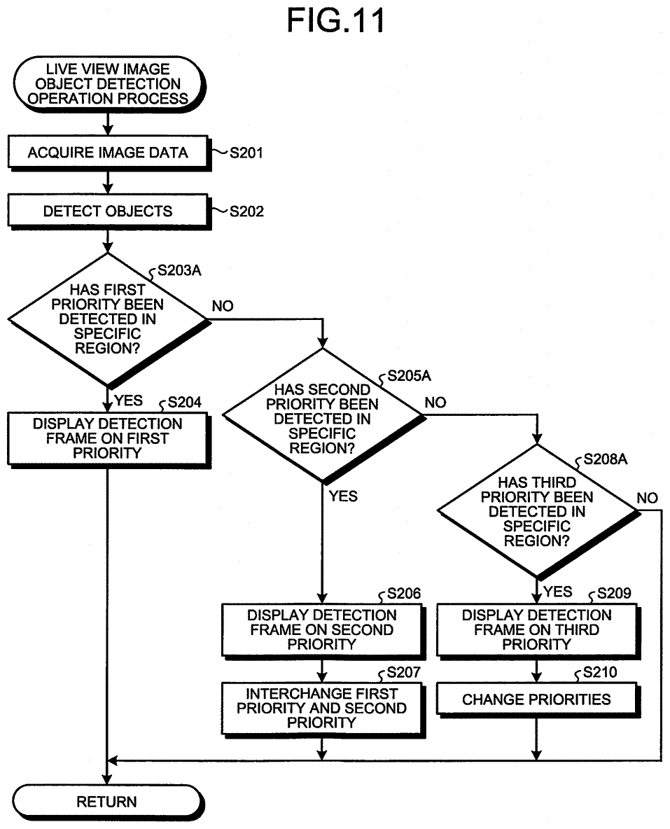

FIG. 11 is a flowchart illustrating an outline of the live view image object detection process performed by the image apparatus 100. Meanwhile, the processing contents in FIG. 11 are the same as those of the live view image object detection process in FIG. 6, except for Step S203A, Step S205A, and Step S208A. In the following, Step S203A, Step S205A, and Step S208A will be described.

At Step S203A, the determination unit 128d determines whether the object detection unit 128b has detected an object with the first priority in the specific region in the image. If the determination unit 128d determines that the object detection unit 128b has detected an object with the first priority in the specific region in the image (Step S203A: Yes), the image apparatus 100 proceeds to Step S204 described above. In contrast, if the determination unit 128d determines that the object detection unit 128b has not detected an object with the first priority in the specific region in the image (Step S203A: No), the image apparatus 100 proceeds to Step S205A to be described below.

At Step S205A, the determination unit 128d determines whether the object detection unit 128b has detected an object with the second priority in the specific region in the image. If the determination unit 128d determines that the object detection unit 128b has detected an object with the second priority in the specific region in the image (Step S205A: Yes), the image apparatus 100 proceeds to Step S206 described above. In contrast, if the determination unit 128d determines that the object detection unit 128b has not detected an object with the second priority in the specific region in the image (Step S205A: No), the image apparatus 100 proceeds to Step S208A to be described below.

At Step S208A, the determination unit 128d determines whether the object detection unit 128b has detected an object with the third priority in the specific region in the image. If the determination unit 128d determines that the object detection unit 128b has detected an object with the third priority in the specific region in the image (Step S208A: Yes), the image apparatus 100 proceeds to Step S209 described above. In contrast, if the determination unit 128d determines that the object detection unit 128b has not detected an object with the third priority in the specific region in the image (Step S208A: No), the image apparatus 100 returns to the main routine of FIG. 5.

According to the third embodiment as described above, when the determination unit 128d determines that the object detection unit 128b has not detected an object with a high priority in the specific region, the change unit 128c changes priorities of a plurality of objects that have been detected by the object detection unit 128b in the specific region. Therefore, even when the number of objects to be detected is increased, it is possible to automatically change the priorities, so that a user is able to easily change the priorities by only continuously capturing a specific desired object within the angle of view or within the finder window.

Meanwhile, in the third embodiment, when the determination unit 128d determines that the object detection unit 128b has not detected an object with a high priority in the specific region, the change unit 128c changes priorities of a plurality of objects that have been detected by the object detection unit 128b in the specific region; however, embodiments are not limited to this example. For example, when the determination unit 128d determines that the object detection unit 128b has not detected an object with a high priority in the specific region in a predetermined time (for example, 3 seconds), it may be possible to change priorities of a plurality of objects that have been detected by the object detection unit 128b in the specific region.

### Fourth Embodiment

Next, a fourth embodiment will be described. An image apparatus according to the fourth embodiment has the same configuration as the image apparatus 100 according to the first embodiment as described above, but performs a different operation process and a different live view image object detection process. Specifically, in the fourth embodiment, priorities of objects are changed in accordance with movement of an imaging visual field with respect to the image apparatus. In the following, the same components as those of the image apparatus 100 according to the first embodiment described above are denoted by the same reference signs, and detailed explanation thereof will be omitted.

Operation Process of Image Apparatus

First, an outline of an operation process performed by the image apparatus 100 will be described.

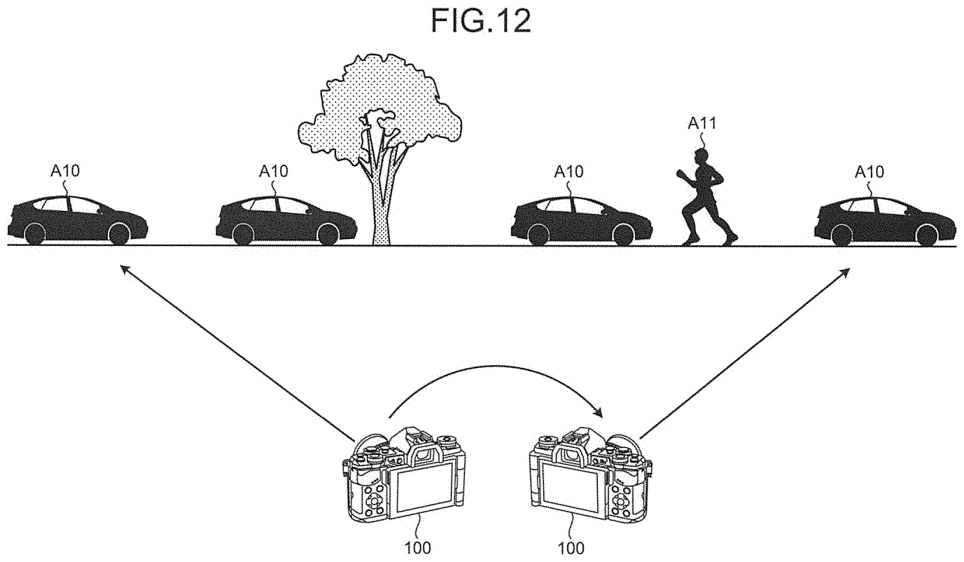

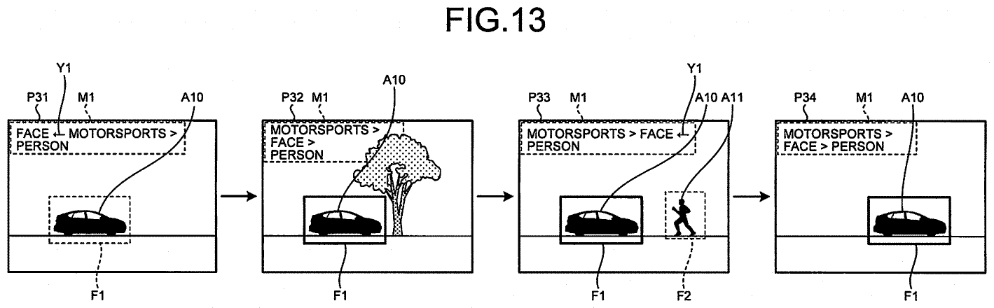

FIG. 12 is a diagram for explaining the outline of the operation process performed by the image apparatus 100. FIG. 13 is a diagram schematically illustrating transition of images corresponding to pieces of image data that are sequentially generated by the image apparatus 100 in the situation illustrated in FIG. 12. In FIG. 12 and FIG. 13, similarly to the first embodiment as described above, a case will be described in which only a person, a face, and a vehicle (motorsports) are adopted as objects for simplicity of explanation. Meanwhile, in FIG. 12 and FIG. 13, a case will be described in which the priority setting unit 128f assigns priorities of the objects to the face, the motorsports, and the person in this order from the highest to the lowest (face>motorsports>person) in accordance with operation on the operating unit 121 before imaging. Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 12 and FIG. 13, embodiments are not limited to this example, and the number of priorities may be appropriately changed.

As illustrated in FIG. 12, the user performs imaging using the image apparatus 100 by moving the image apparatus 100 from right to left while tracking an object A10 (motorsports) such that the object A10 appears in the angle of view. In this case, as illustrated in FIG. 13, the object A10, i.e., a vehicle (motorsports), appears in an image P31 generated by the image apparatus 100. Therefore, the object detection unit 128b detects the object A10 (second priority) that appears in the image P31. In this case, the display control unit 128g causes the eyepiece display unit 118 to display, in a blinking manner, the detection frame F1 in an area including the object A10 on the image P31. Further, the display control unit 128g causes the eyepiece display unit 118 to display, in a superimposed manner, the priority information M1 related to the current priorities of the objects on the image P1. In this case, the display control unit 128g causes the eyepiece display unit 118 to display the warning Y1, which indicates that the priorities are to be changed, in the priority information M1 in a superimposed manner,. Therefore, the user is able to intuitively recognize that the priorities are to be changed.

Subsequently, as illustrated in FIG. 12 and FIG. 13, in an image P32 generated by the image apparatus 100, the object A10 (second priority) appears because the user tracks the object A10 as a main object. In this case, the determination unit 128d determines that the object detection unit 128b has not detected the object (first priority) with a high priority in the predetermined time based on the time information input from the clock unit 128e or based on operation on the operating unit 121, so that the change unit 128c increases the priority of the object A10 (second priority) detected by the object detection unit 128b. Specifically, the change unit 128c changes the priority of the object A10 to the first priority, and changes the priority of the face to the second priority (motorsports>face>person). Further, the display control unit 128g causes the eyepiece display unit 118 to display, in a superimposed manner, the priority information M1 (motorsports>face>person) related to the current priorities of the objects on the image P1.

Thereafter, as illustrated in FIG. 12 and FIG. 13, in an image P33 generated by the image apparatus 100, an object A11, i.e., a person, appears in addition to the object A10 (first priority) because the user tracks the object A10 as the main object. In this case, the object detection unit 128b detects the object A10 (first priority) and the object A11 (third priority) from the image P33. Further, the display control unit 128g causes the eyepiece display unit 118 to display, in a superimposed manner, the detection frame F1 in an area including the object A10 on the image P33. Furthermore, the display control unit 128g causes the eyepiece display unit 118 to display, in a blinking manner or in a highlighted manner, a candidate frame F2 indicating a candidate object in an area including the object A11 (person) detected by the object detection unit 128b on the image P33. Therefore, the user is able to intuitively recognize the candidate object. Moreover, the display control unit 128g causes the eyepiece display unit 118 to display, in a superimposed manner, the warning Y1 indicating that the priorities are to be changed in the priority information M1. In this case, the determination unit 128d determines whether an instruction signal for changing the main object is input from the operating unit 121. In this situation, the user is tracking the object A10 and therefore does not perform operation of changing the main object through the operating unit 121. Therefore, the determination unit 128d determines that the instruction signal is not input from the operating unit 121, so that the change unit 128c increases the priority of only the object A11 (third priority) detected by the object detection unit 128b. Specifically, the change unit 128c changes the priority of the object A11 to the second priority.

Subsequently, as illustrated in FIG. 12 and FIG. 13, in an image P34 generated by the image apparatus 100, the object A10 (first priority) appears because the user tracks the object A10 as the main object. In this case, the object detection unit 128b detects the object A10 (second priority) that appears in the image P34. In this case, the display control unit 128g causes the eyepiece display unit 118 to display, in a superimposed manner, the detection frame F1 in an area including the object A10 on the image P34. Further, the display control unit 128g causes the eyepiece display unit 118 to display, in a superimposed manner, the priority information M1 related to the current priorities of the objects on the image P34.

Outline of Live View Image Object Detection Process

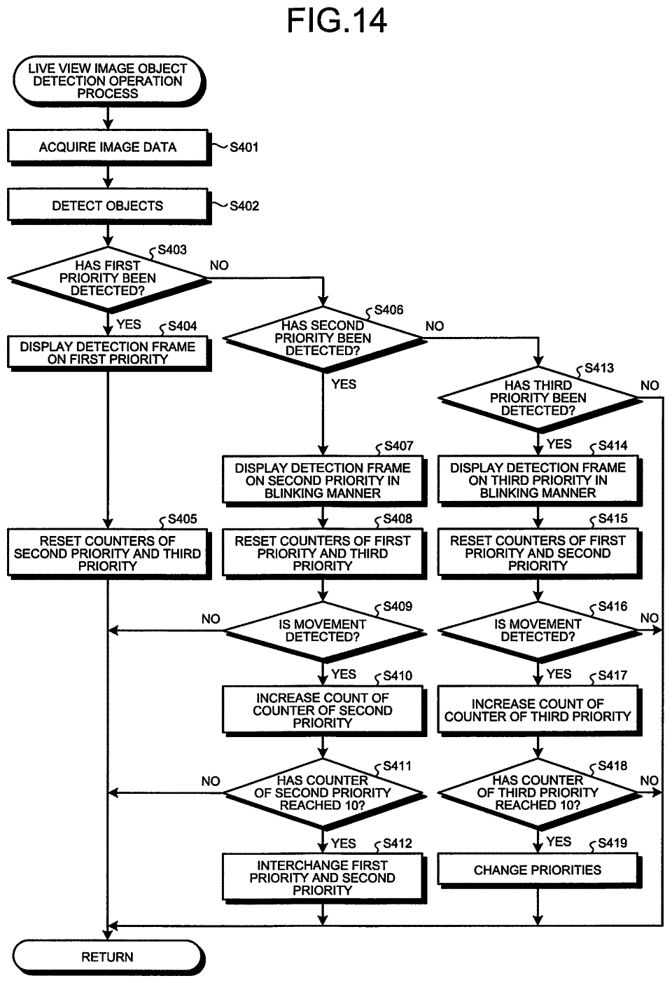

Next, a live view image object detection process performed by the image apparatus 100 will be described. FIG. 14 is a flowchart illustrating an outline of the live view image object detection process performed by the image apparatus 100. In FIG. 14, Step S401 to Step S407 respectively correspond to Step S301 to Step S307 of FIG. 8 described above.

At Step S408, the determination unit 128d resets counts of the first priority and the third priority detected by the object detection unit 128b, based on the time information input from the clock unit 128e.

Subsequently, the determination unit 128d determines whether the image apparatus 100 is moving an imaging visual field, based on a detection signal input from the moving state detection unit 127 (Step S409). If the determination unit 128d determines that the image apparatus 100 is moving the imaging visual field (Step S409: Yes), the image apparatus 100 proceeds to Step S410 to be described later. In contrast, if the determination unit 128d determines that the image apparatus 100 is not moving the imaging visual field (Step S409: No), the image apparatus 100 returns to the main routine of FIG. 5 described above.

At Step S410, the determination unit 128d increases a count of the object with the second priority to change the priority to the first priority, based on the time information input from the clock unit 128e. Step S411 to Step S414 respectively correspond to Step S310 to Step S313 of FIG. 8 described above.

At Step S415, the determination unit 128d resets counts of the first priority and the second priority detected by the object detection unit 128b, based on the time information input from the clock unit 120e.

At Step S416, the determination unit 128d determines whether the image apparatus 100 is moving the imaging visual field, based on the detection signal input from the moving state detection unit 127. If the determination unit 128d determines that the image apparatus 100 is moving the imaging visual field (Step S416: Yes), the image apparatus 100 proceeds to Step S417 to be described later. In contrast, if the determination unit 128d determines that the image apparatus 100 is not moving the imaging visual field (Step S416: No), the image apparatus 100 returns to the main routine of FIG. 5 described above.

At Step S417, the determination unit 128d increases a count of the object with the third priority to change the priority to the first priority, based on the time information input from the clock unit 128e. Step S418 and Step S419 respectively correspond to Step S316 and Step S317 of FIG. 8 described above. After Step S419, the image apparatus 100 returns to the main routine of FIG. 5.

According to the fourth embodiment as described above, when the determination unit 128d determines that the object detection unit 128b has not detected an object with a high priority during a period in which the image apparatus 100 is moving, the change unit 128c changes priorities of a plurality of objects that have been detected by the object detection unit 128b during the period in which the image apparatus 100 is moving. Therefore, even when the number of objects to be detected is increased, it is possible to automatically change the priorities, so that a user is able to easily change the priorities by only continuously capturing a specific desired object within the angle of view or within the finder window.

Meanwhile, in the fourth embodiment, for example, when the determination unit 128d determines that the object detection unit 128b has not detected an object with a high priority in the specific region in a predetermined time (for example, 3 seconds) during the period in which the image apparatus 100 is moving, the change unit 128c may change priorities of a plurality of objects that have been detected by the object detection unit 128b in the specific region.

### Fifth Embodiment

Next, a fifth embodiment will be described. An image apparatus according to the fifth embodiment has the same configuration as the image apparatus 100 according to the first embodiment as described above, but performs a different operation process, a different imaging preparation operation process, and a different live view image object detection process. Specifically, in the fifth embodiment, priorities are changed in accordance with operation on the operating unit of the image apparatus. In the following, the same components as those of the image apparatus 100 according to the first embodiment described above are denoted by the same reference signs, and detailed explanation thereof will be omitted.

Operation Process of Image Apparatus

First, an outline of an operation process performed by the image apparatus 100 will be described.

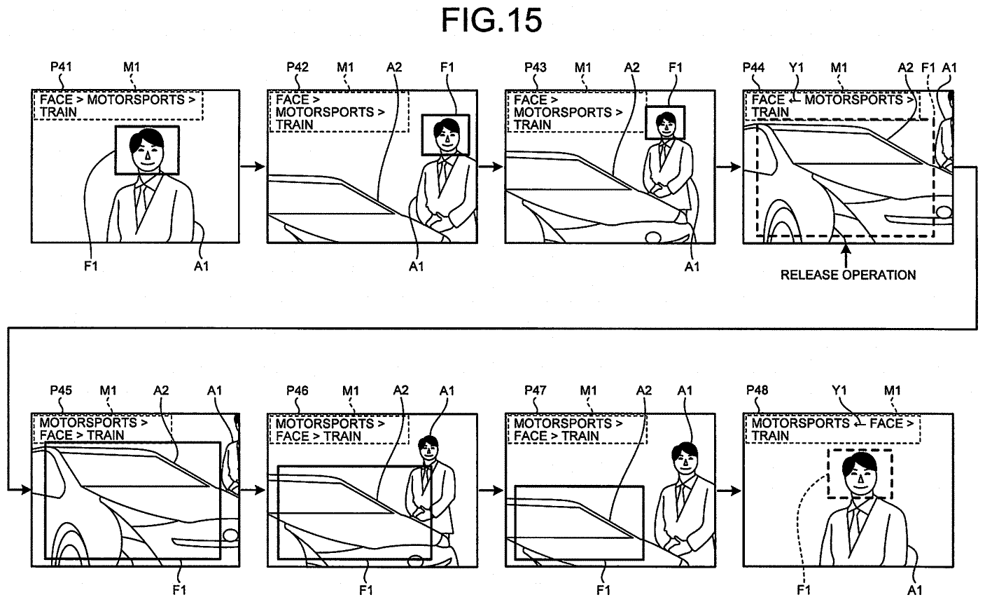

FIG. 15 is a diagram for explaining the outline of the operation process performed by the image apparatus 100. In FIG. 15, similarly to the first to fourth embodiments as described above, a case will be described in which only a face, a vehicle (motorsports), and a train are adopted as objects for simplicity of explanation. Meanwhile, in FIG. 15, a case will be described in which the priority setting unit 128f assigns priorities of the objects to the face, the motorsports, and the train in this order from the highest to the lowest (face>motorsports>train) in accordance with operation on the operating unit 121 before imaging. Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 15, embodiments are not limited to this example, and the number of priorities may be appropriately changed.

As illustrated in FIG. 15, first, the object detection unit 128b detects the face of the object A1 that appears in an image P41, an image P42, and an image P43 that are sequentially generated by the image apparatus 100. In this case, the display control unit 128g causes the eyepiece display unit 118 to display, in a superimposed manner, the detection frame F1 in an area including the face of the object A1 on each of the image P41, the image P42, and the image P43. Further, the display control unit 128g causes the eyepiece display unit 118 to display, in a superimposed manner, the priority information M1 related to the current priorities of the objects on the image P41.

Subsequently, in the image P42 and the image P43 that are sequentially generated by the image apparatus 100 (the image P41→the image P42→the image P43), the object A2 (second priority), i.e., a vehicle (motorsports), appears in addition to the object A1 in accordance with user operation of changing the composition or the angle of view of the imaging area of the image apparatus 100. In this case, the object detection unit 128b detects the face of the object A1 and the object A2 from each of the image P42 and the image P43. In this case, the display control unit 128g causes the eyepiece display unit 118 to display, in a superimposed manner, the detection frame F1 in an area including the face of the object A1 on each of the image P42 and the image P43 because the priority of the object A1 is set to the first priority. Further, the display control unit 128g causes the eyepiece display unit 118 to display, in a superimposed manner, the priority information M1 related to the current priorities of the objects on each of the image P42 and the image P43.

Thereafter, in an image P44 generated by the image apparatus 100, only the object A2 (second priority) appears in accordance with user operation of changing the composition or the angle of view of the imaging area of the image apparatus 100. In this case, the object detection unit 128b detects the object A2 (second priority) but does not detect the object A1 (first priority) from the image P44. In this case, the display control unit 128g causes the eyepiece display unit 118 to display, in a blinking manner or in a highlighted manner, the detection frame F1 in an area including the object A2 detected by the object detection unit 128b on the image P44. Further, the display control unit 128g causes the eyepiece display unit 118 to display, in a superimposed manner, the warning Y1 indicating that the priorities are changeable in the priority information M1.

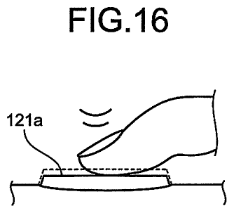

Subsequently, at a timing of an image P45 generated by the image apparatus 100, if the user presses the shutter button 121a halfway as illustrated in FIG. 16, the change unit 128c changes the priorities. Specifically, the change unit 128c changes the priority of the object A2 to the first priority, and changes the priority of the object A1 to the second priority (motorsports>face>train). Consequently, it is possible to automatically increase the priority of the object A2 and easily perform imaging such that the object is arranged as a main object in user's desired composition.

Thereafter, in an image P46 and an image P47 that are sequentially generated by the image apparatus 100, the object A2 (first priority) and the object A1 appears in accordance with user operation of changing the composition or the angle of view of the imaging area of the image apparatus 100. In this case, the object detection unit 128b detects the object A2 and the object A1 from each of the image P46 and the image P47. In this case, the display control unit 128g causes the eyepiece display unit 118 to display, in a superimposed manner, the detection frame F1 in an area including the object A2 detected by the object detection unit 128b because the priority of the object A2 is set to the first priority.

Thereafter, in an image P48 generated by the image apparatus 100, only the object A1 (second priority) appears in accordance with user operation of changing the composition or the angle of view of the imaging area of the image apparatus 100. In this case, the object detection unit 128b detects the object A1 (second priority) but does not detect the object A2 (first priority) from the image P48. Further, the display control unit 128g causes the eyepiece display unit 118 to display, in a blinking manner or in a highlighted manner, the detection frame F1 in an area including the object A1 detected by the object detection unit 128b on the image P48. Furthermore, the display control unit 128g causes the eyepiece display unit 118 to display the warning Y1, which indicates that the priorities are changeable, in the priority information M1 in a superimposed manner. In this case, the change unit 128c changes the priorities when the user presses the shutter button 121a halfway. Specifically, the change unit 128c changes the priority of the object A1 to the first priority, and changes the priority of the object A2 to the second priority (face>motorsports>train). Consequently, it is possible to automatically increase the priority of the object A1 and easily perform imaging such that the object is arranged as a main object in user's desired composition.

Operation Process at Time of Cancellation Operation

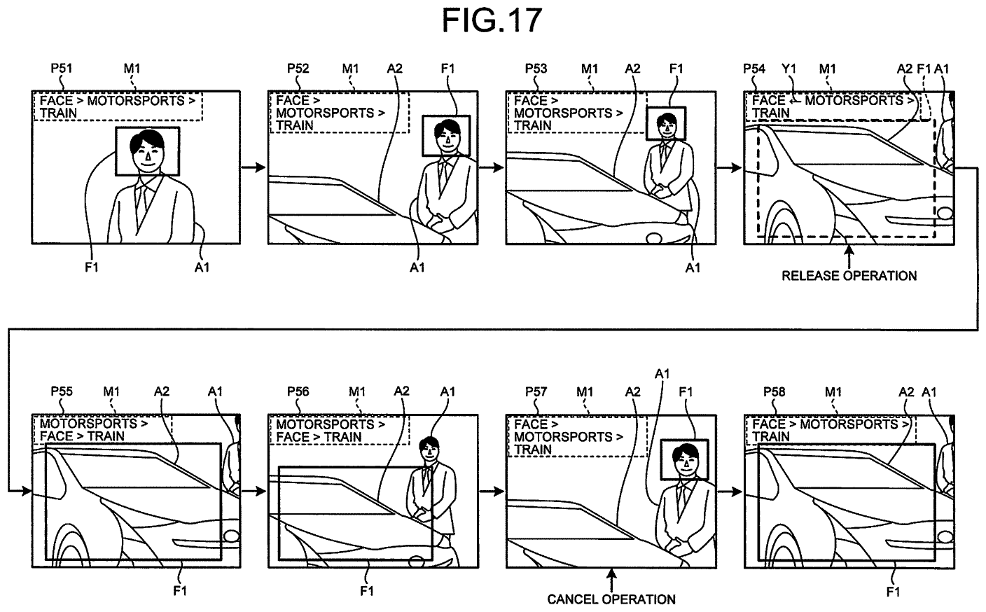

Next, an outline of an operation process that is performed by the image apparatus 100 at the time of cancel operation. FIG. 17 is a diagram for explaining the outline of the operation process that is performed by the image apparatus 100 at the time of cancel operation. In FIG. 17, similarly to FIG. 15 as described above, a case will be described in which only a face, a vehicle (motorsports), and a train are adopted as objects for simplicity of explanation. Meanwhile, in FIG. 17, a case will be described in which the priority setting unit 128f assigns priorities of the objects to the face, the motorsports, and the train in this order from the highest to the lowest (face>motorsports>train). Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 17, embodiments are not limited to this example, and the number of priorities may be appropriately changed. Furthermore, in FIG. 17, operation performed by the image apparatus 100 on an image P51 to an image P56 is the same as the operation performed on the image P41 to the image P46 in FIG. 15 described above, and therefore, detailed explanation thereof will be omitted.

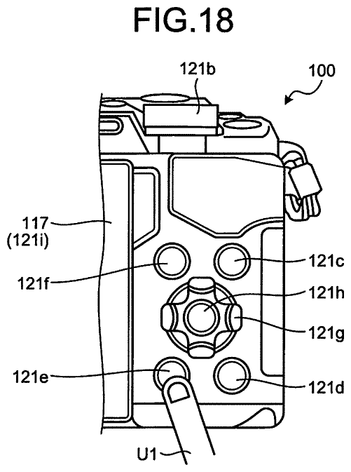

In FIG. 17, after the image apparatus 100 has generated the image P56, at a timing of an image P57 generated by the image apparatus 100, if a cancel signal is input by a user by pressing the cancel button 121e as illustrated in FIG. 18, the change unit 128c changes the priorities to previous priorities and inhibits a change of the priorities. Specifically, the change unit 128c changes the priority of the object A2 (motorsports) to the second priority, and changes the priority of the object A1 (face) to the first priority. In this case, the display control unit 128g causes the eyepiece display unit 118 to display, in a superimposed manner, the detection frame F1 in an area including the face of the object A1 on the image P57 because the priority of the object A1 is set to the first. priority.

Thereafter, in an image P58 generated by the image apparatus 100, only the object A2 (second priority) appears in accordance with user operation of changing the composition or the angle of view of the imaging area of the image apparatus 100. In this case, the object detection unit 128b detects the object A2 (second priority) but does not detect the object A1 (first priority) from the image P58. In this case, the change unit 128c does not change the priorities because a change of the priorities is inhibited. Further, the display control unit 128g causes the eyepiece display unit 118 to display, in a superimposed manner, the detection frame F1 in an area including the object with the second priority A2 detected by the object detection unit 128b on the image P58. In other words, when the object detection unit 128b detects the face of the object A1, the display control unit 128g immediately changes a display mode and causes the eyepiece display unit 118 to display, in a superimposed manner, the detection frame F1 in an area including the face of the object A1. Consequently, even when an object desired by the user moves to the outside of the imaging visual field of the image apparatus 100, if the object appears again in the imaging visual field of the image apparatus 100, it is possible to immediately adjust an AF target to the object desired by the user.

Imaging Preparation Operation Process

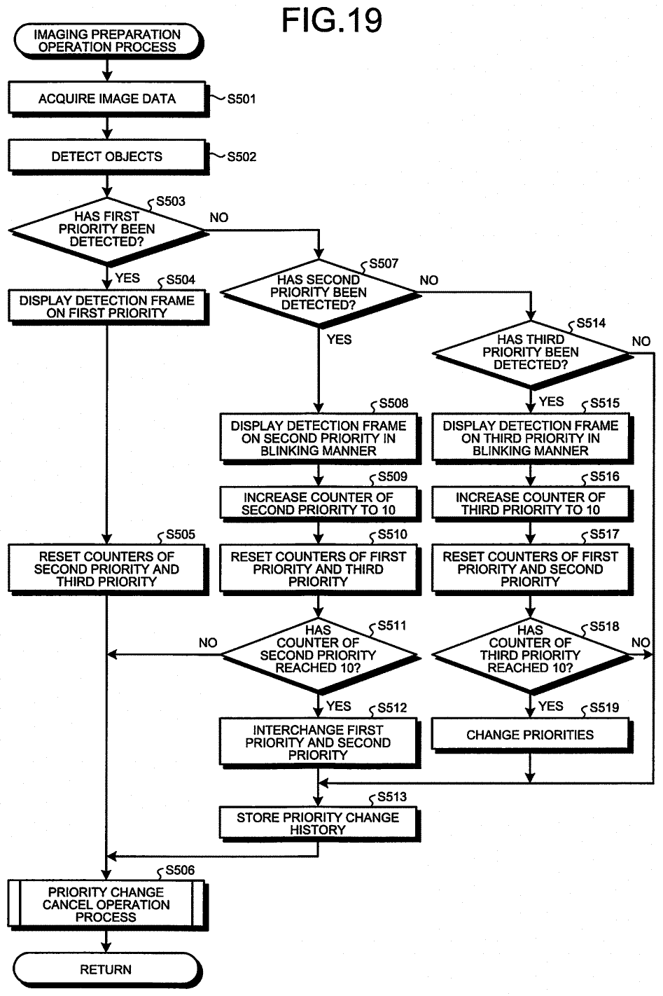

Next, the imaging preparation operation process performed by the image apparatus 100 will be described. FIG. 19 is a flowchart illustrating an outline of the imaging preparation operation process performed by the image apparatus 100.

As illustrated in FIG. 19, first, the acquiring unit 128a acquires image data from the memory 110 (Step S501).

Subsequently, the object detection unit 128b detects a plurality of objects from an image corresponding to the image data acquired by the acquiring unit 128a (Step S502).

Thereafter, the determination unit 128d determines whether the object detection unit 128b has detected an object with the first priority from the image (Step S503). If the determination unit 128d determines that the object detection unit 128b has detected an object with the first priority from the image (Step S503: Yes), the image apparatus 100 proceeds to Step S504 to be described later. In contrast, if the determination unit 128d determines that the object detection unit 128b has not detected an object with the first priority from the image (Step S503: No), the image apparatus 100 proceeds to Step S507 to be described later.

At Step S504, the display control unit 128g causes the eyepiece display unit 118 to display, in a superimposed manner, the detection frame F1 in an area including the object with the first priority detected by the object detection unit 128b on the image. In this case, the display control unit 128g may cause the eyepiece display unit 118 to display, in a superimposed manner, the priority information M1 related to the current priorities of the objects on the image.

Subsequently, the determination unit 128d resets counts of the second priority and the third priority detected by the object detection unit 128b, based on the time information input from the clock unit 128e (Step S505).

Thereafter, the image apparatus 100 performs a priority change cancel operation process for cancelling a change of the priorities in accordance with operation on the operating unit 121 (Step S506). Meanwhile, the priority change cancel operation process will be described in detail later. After Step S506, the image apparatus 100 returns to the main routine of FIG. 5.

At Step S507, the determination unit 128d determines whether the object detection unit 128b has detected an object with the second priority in the image. If the determination unit 128d determines that the object detection unit 128b has detected an object with the second priority in the image (Step S507: Yes), the image apparatus 100 proceeds to Step S508 to be described later. In contrast, if the determination unit 128d determines that the object detection unit 128b has not detected an object with the second priority in the image (Step S507: No), the image apparatus 100 proceeds to Step S514 to be described later.

At Step S508, the display control unit 128g causes the eyepiece display unit 118 to display, in a blinking manner, the detection frame F1 in an area including the object with the second priority detected by the object detection unit 128b on the image.

Subsequently, the determination unit 128d increases a count of the object with the second priority to 10 (the count of the second priority=10) (Step S509), and resets counts of the first priority and the third priority (Step S510).

Thereafter, the determination unit 128d determines whether the count of the object with the second priority has reached a predetermined time (count=10) (Step S511). If the determination unit 128d determines that the count of the object with the second priority has reached the predetermined time (Step S511: Yes), the image apparatus 100 proceeds to Step S512 to be described later. In contrast, if the determination unit 128d determines that the count of the object with the second priority has reached the predetermined time (Step S511: No), the image apparatus 100 proceeds to Step S506 to be described later.

At Step S512, the change unit 128c changes the priority of the object with the second priority detected by the object detection unit 128b to the first priority, and changes the priority of the object with the first priority to the second priority. In this case, the display control unit 128g causes the eyepiece display unit 118 to display, in a superimposed manner, the detection frame in an area including the object whose priority is changed to the first priority.

Thereafter, the system control unit 128 stores a priority change history in the non-volatile memory 114 (Step S513). After Step S513, the image apparatus 100 proceeds to Step S506 to be described later.

At Step S514, the determination unit 128d determines whether the object detection unit 128b has detected an object with the third priority in the image. If the determination unit 128d determines that the object detection unit 128b has detected an object with the third priority in the image (Step S514: Yes), the image apparatus 100 proceeds to Step S515 to be described later. In contrast, if the determination unit 128d determines that the object detection unit 128b has detected an object with the third priority in the image (Step S514: No), the image apparatus 100 proceeds to Step S506 to be described later.

At Step S515, the display control unit 128g causes the eyepiece display unit 118 to display, in a blinking manner, the detection frame F1 in an area including the object with the third priority detected by the object detection unit 128b on the image.

Subsequently, the determination unit 128d increases a count of the object with the third priority to 10 (the count of the third priority=10) (Step S516), and resets counts of the first priority and the second priority (Step S517).

Thereafter, the determination unit 128d determines whether the count of the object with the third priority has reached a predetermined time (count=10) (Step S518). If the determination unit 128d determines that the count of the object with the third priority has reached the predetermined time (Step S518: Yes), the image apparatus 100 proceeds to Step S519 to be described later. In contrast, if the determination unit 128d determines that the count of the object with the third priority has not reached the predetermined time (Step S518: No), the image apparatus 100 proceeds to Step S506.

At Step S519, the change unit 128c changes the priority of the object with the third priority detected by the object detection unit 128b to the first priority, changes the priority of the object with the first priority to the second priority, and changes the priority of the object with the second priority to the third priority. In this case, the display control unit 128g causes the eyepiece display unit 118 to display, in a superimposed manner, the detection frame in an area including the object whose priority is changed to the first priority. After Step S519, the image apparatus 100 proceeds to Step S506 to be described later.

Priority Change Cancel Operation Process

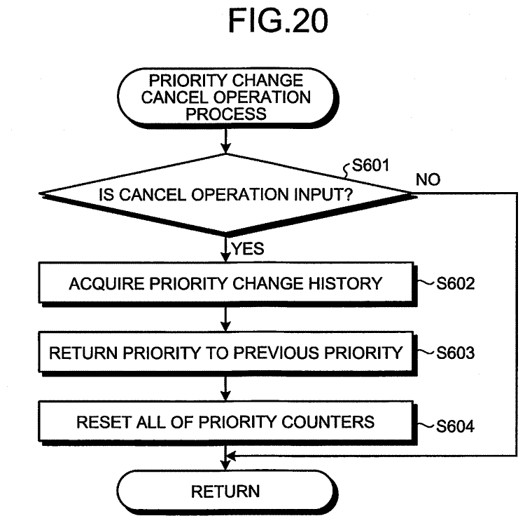

Next, the priority change cancel operation process explained at Step S506 in FIG. 19 will be described in detail below. FIG. 20 is a flowchart illustrating an outline of the priority change cancel operation process.

As illustrated in FIG. 20, if an instruction signal for cancelling a change of the priorities is input from the cancel button 121e of the operating unit 121 (Step S601: Yes), the change unit 128c acquires the priority change history from the non-volatile memory 114 (Step S602).

Subsequently, the change unit 128c returns the priority of each of the objects to a previous priority (Step S603), and resets all of counts of the priorities of the objects (Step S604). After Step S604, the image apparatus 100 returns to the sub routine of FIG. 19 and then returns to the main routine of FIG. 5.

At Step S601, if the instruction signal for cancelling a change of the priorities is not input from the cancel button 121e of the operating unit 121 (Step S601: No), the image apparatus 100 returns to the sub routine of FIG. 19 and then returns to the main routine of FIG. 5.

Live View Image Object Detection Operation Process

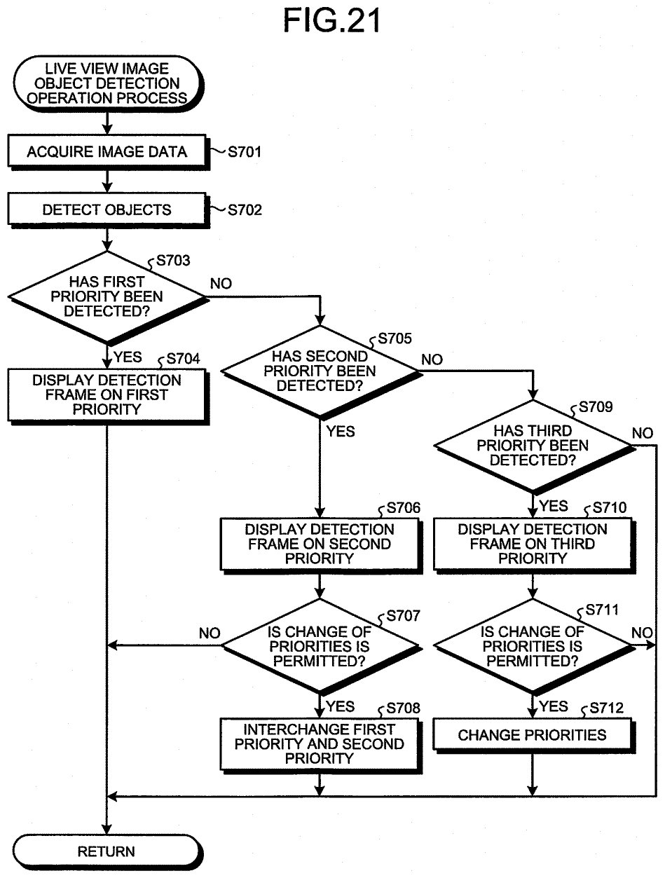

Next, a live view image object detection process performed by the image apparatus 100 will be described. FIG. 21 is a flowchart illustrating an outline of the live view image object detection process performed by the image apparatus 100. Step S701 to Step S706 respectively correspond to Step S201 to Step S206 of FIG. 6 described above.

At Step S707, the determination unit 128d determines whether a change of the priorities is permitted, based on the priority change history recorded in the non-volatile memory 114. If the determination unit 128d determines that a change of the priorities is permitted (Step S707: Yes), the image apparatus 100 proceeds to Step S708 to be described later. In contrast, if the determination unit 128d determines that a change of the priorities is not permitted (Step S707: No), the image apparatus 100 returns to the main routine of FIG. 5.

Step S708 to Step S710 respectively correspond to Step S207 to Step S209 of FIG. 6 described above.

At Step S711, the determination unit 128d determines whether a change of the priorities is permitted, based on the priority change history recorded in the non-volatile memory 114. If the determination unit 128d determines that a change of the priorities is permitted (Step S711: Yes), the image apparatus 100 proceeds to Step S712 to be described later. In contrast, if the determination unit 128d determines that a change of the priorities is not permitted (Step S711: No), the image apparatus 100 returns to the main routine of FIG. 5.

Step S712 corresponds to Step S210 of FIG. 6 described above. After Step S712, the image apparatus 100 returns to the main routine of FIG. 5.

According to the fifth embodiment as described above, when the shutter button 121a is operated, and if the determination unit 128d determines that the object detection unit 128b has not detected an object with a high priority, the change unit 128c increases the priorities of the objects that have been detected by the object detection unit 128b. Therefore, even when the number of objects to be detected is increased, it is possible to immediately change the priorities in accordance with operation performed by the user, so that it is possible to easily change the priorities at a timing desired by the user.

Meanwhile, in the fifth embodiment, when the determination unit 128d determines that the object detection unit 128b has not detected an object with a high priority in the specific region in a predetermined time (for example, 3 seconds) during a period in which the image apparatus 100 is moving, and if the user performs operation on the operating unit 121, the change unit 128c may change priorities of a plurality of objects that have been detected by the object detection unit 128b in the specific region.

Furthermore, in the fifth embodiment, when the shutter button 121a is operated, the change unit 128c increases the priorities of the objects that have been detected by the object detection unit 128b; however, the change unit 128c may change the priorities using other than the shutter button 121a. For example, when various buttons or switches, which enable execution of enlargement operation of displaying an area including the point of focus in a full-screen manner when the point of focus is to be checked, which enable trimming operation (digital zoom operation) of extracting and enlarging a predetermined area, and which enable AF operation, i.e., what is called thumb AF, of adjusting the point of focus to a main object, are operated, and if the determination unit 128d determines that the object detection unit 128b has not detected an object with a high priority, the change unit 128c may increase the priorities of the objects that have been detected by the object detection unit 128b.

### Sixth Embodiment

Next, a sixth embodiment will be described. An image apparatus according to the sixth embodiment has the same configuration as the image apparatus 100 according to the fifth embodiment as described above, but performs a different operation process. Specifically, in the fifth embodiment as described above, the priorities are changed when the shutter button 121a is pressed halfway; however, in the sixth embodiment, the priorities are changed when zoom operation is performed. In the following, the same components as those of the image apparatus 100 according to the fifth embodiment described above are denoted by the same reference signs, and detailed explanation thereof will be omitted.

Operation Process of Image Apparatus

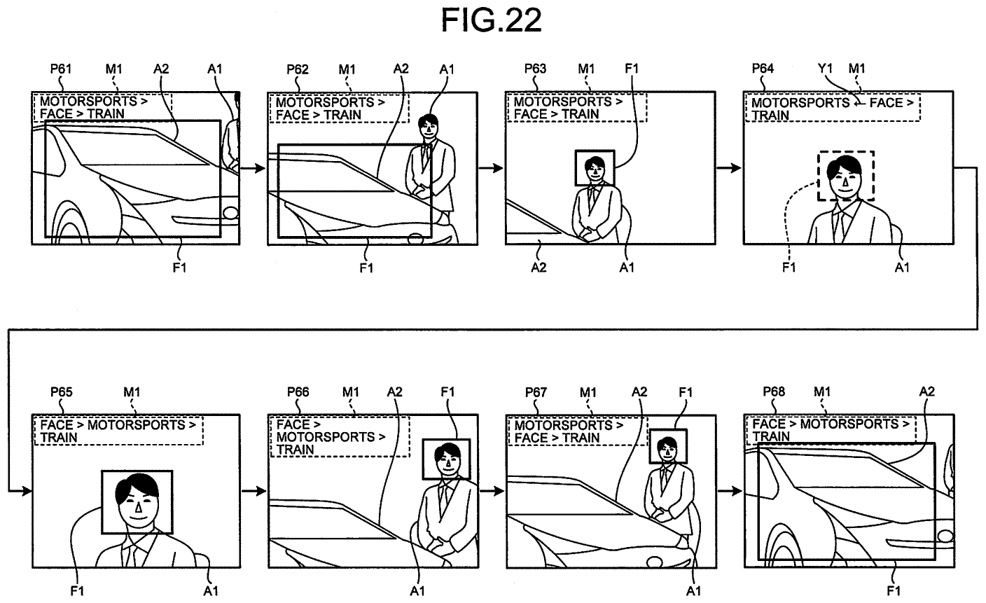

First, an outline of an operation process performed by the image apparatus 100 according to the sixth embodiment will be described. FIG. 22 is a diagram for explaining the outline of the operation process performed by the image apparatus 100 according to the sixth embodiment. In FIG. 22, similarly to FIG. 15 explained in the fifth embodiment described above, a case will be described in which only a face, a vehicle (motorsports), and a train are adopted as objects for simplicity of explanation. Meanwhile, in FIG. 22, a case will be described in which the priority setting unit 128f assigns priorities of the objects to the face, the motorsports, and the train in this order from the highest to the lowest (face>motorsports>train) in accordance with operation on the operating unit 121 before imaging. Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 22, embodiments are not limited to this example, and the number of priorities may be appropriately changed. Furthermore, in FIG. 22, operation performed by the image apparatus 100 on an image P61 to an image P64 is the same as the operation performed on the image P41 to the image P46 in FIG. 15 described above, and therefore, detailed explanation thereof will be omitted.

In FIG. 22, when a user performs zoom operation by operating the operating unit 121 after the image apparatus 100 has generated the image P64, the change unit 128c changes the priorities as illustrated in an image P65 generated by the image apparatus 100. Specifically, the change unit 128c changes the priority of the object A1 (face) to the first priority. In this case, the display control unit 128g causes the eyepiece display unit 118 to display, in a superimposed manner, the detection frame F1 in an area including the face of the object A1 on the image P65 because the priority of the object A1 is set to the first priority.

Subsequently, in an image P66 and an image P67 that are sequentially generated by the image apparatus 100, the object A1 (first priority) and the object A2 appear in accordance with user operation of changing the composition or the angle of view of the imaging area of the image apparatus 100. In this case, the object detection unit 128b detects the object A2 and the object A1 from each of the image P66 and the image P67. In this case, the display control unit 128g causes the eyepiece display unit 118 to display, in a superimposed manner, the detection frame F1 in an area including the face of the object A1 detected by the object detection unit 128b because the priority of the object A1 is set to the first priority.

Thereafter, in an image P68 generated by the image apparatus 100, the object A2 (second priority) appears in accordance with user operation of changing the composition or the angle of view of the imaging area of the image apparatus 100. In this case, the object detection unit 128b detects the object A2 (second priority) but does not detect the object A1 (first priority) from the image P68. In this case, the change unit 128c does not change the priorities because a change of the priorities is inhibited. Further, the display control unit 128g causes the eyepiece display unit 118 to display, in a superimposed manner, the detection frame F1 in an area including the object A2 with the second priority detected by the object detection unit 128b on the image P68. In other words, when the object detection unit 128b detects the face of the object A1, the display control unit 128g immediately changes a display mode and causes the eyepiece display unit 118 to display, in a superimposed manner, the detection frame F1 in an area including the face of the object A1. Consequently, even when an object desired by the user moves to the outside of the imaging visual field of the image apparatus 100, if the object appears again in the imaging visual field of the image apparatus 100, it is possible to immediately adjust an AF target to the object desired by the user.

According to the sixth embodiment as described above, when a part of an image is enlarged by operation on the operating unit 121, and if the determination unit 128d determines that the object detection unit 128b has not detected an object with a high priority, the change unit 128c increases the priorities of the objects that have been detected by the object detection unit 128b. Therefore, even when the number of objects to be detected is increased, it is possible to immediately change the priorities in accordance with operation performed by the user, so that it is possible to easily change the priorities at a timing desired by the user.

### Seventh Embodiment

Next, a seventh embodiment will be described. An image apparatus according to the seventh embodiment has the same configuration as the image apparatus 100 according to the fifth embodiment as described above, but performs a different operation process and a different live view image object detection process. Specifically, in the fifth embodiment as described above, the priorities are changed when the shutter button 121a is pressed halfway; however, in the seventh embodiment, the priorities are changed by touching the touch panel 121i. In the following, the same components as those of the image apparatus 100 according to the fifth embodiment described above are denoted by the same reference signs, and detailed explanation thereof will be omitted.

Operation Process of Image Apparatus

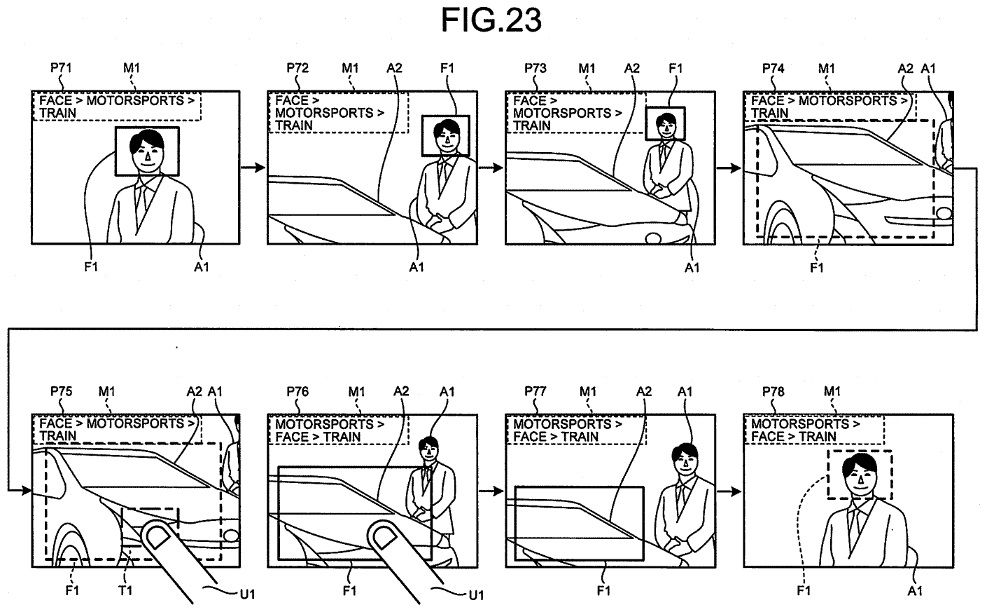

First, an outline of an operation process performed by the image apparatus 100 according to the seventh embodiment will be described. FIG. 23 is a diagram for explaining the outline of the operation process performed by the image apparatus 100 according to the seventh embodiment. In FIG. 23, similarly to FIG. 15 explained in the fifth embodiment described above, a case will be described in which only a face, a vehicle (motorsports), and a train are adopted as objects for simplicity of explanation. Meanwhile, in FIG. 23, a case will be described in which the priority setting unit 128f assigns priorities of the objects to the face, the motorsports, and the train in this order from the highest to the lowest (face>motorsports>train). Furthermore, in the following, a case will be described in which a user performs imaging while viewing the eyepiece display unit 118, but the same applies to a case in which a user performs imaging using the display unit 117 or the external display device 200. Moreover, while three priorities are set in FIG. 23, embodiments are not limited to this example, and the number of priorities may be appropriately changed. Furthermore, in FIG. 23, operation performed by the image apparatus 100 on an image P71 to an image P74 is the same as the operation performed on the image P41 to the image P44 in FIG. 15 described above, and therefore, detailed explanation thereof will be omitted.

In FIG. 23, after the image apparatus 100 has generated the image P74, when a user touches the desired object A2 (motorsports) using the touch panel 121i as illustrated in an image P75 and an image P76 generated by the image apparatus 100, the change unit 128c changes the priorities based on a position of a touch area T1. Specifically, the change unit 128c changes the priority of the object A2 (motorsports) to the first priority. In this case, the display control unit 128g causes the eyepiece display unit 118 to display, in a superimposed manner, the detection frame F1 in an area including the object A2 on the image P75 because the priority of the object A2 is set to the first priority (the image P74→the image P75→the image P76).

Subsequently, in the image P76 and an image P77 that are sequentially generated by the image apparatus 100, the object A1 (first priority) and the object A2 appear in accordance with user operation of changing the composition or the angle of view of the imaging area of the image apparatus 100. In this case, the object detection unit 128b detects the object A2 and the object A1 from each of the image P76 and the image P77. In this case, the display control unit 128g causes the eyepiece display unit 118 to display, in a superimposed manner, the detection frame F1 in an area including the object A2 (motorsports) detected by the object detection unit 128b because the priority of the object A1 is set to the second priority.

Thereafter, in an image P78 generated by the image apparatus 100, the object A1 (second priority) appears in accordance with user operation of changing the composition or the angle of view of the imaging area of the image apparatus 100. In this case, the object detection unit 128b detects the object A1 (second priority) but does not detect the object A2 (first priority) from the image P78. In this case, the change unit 128c does not change the priorities because a change of the priorities is inhibited (motorsports>face>train). Further, the display control unit 128g causes the eyepiece display unit 118 to display, in a superimposed manner, the detection frame F1 in an area including the face of the object A1 with the second priority detected by the object detection unit 128b on the image P78. In other words, when the object detection unit 128b detects the object A2, the display control unit 128g immediately changes a display mode and causes the eyepiece display unit 118 to display, in a superimposed manner, the detection frame F1 in an area including the object A2. Consequently, even when an object desired by the user moves to the outside of the imaging visual field of the image apparatus 100, if the object appears again in the imaging visual field of the image apparatus 100, it is possible to immediately adjust an AF target to the object desired by the user.

Live View Image Object Detection Process

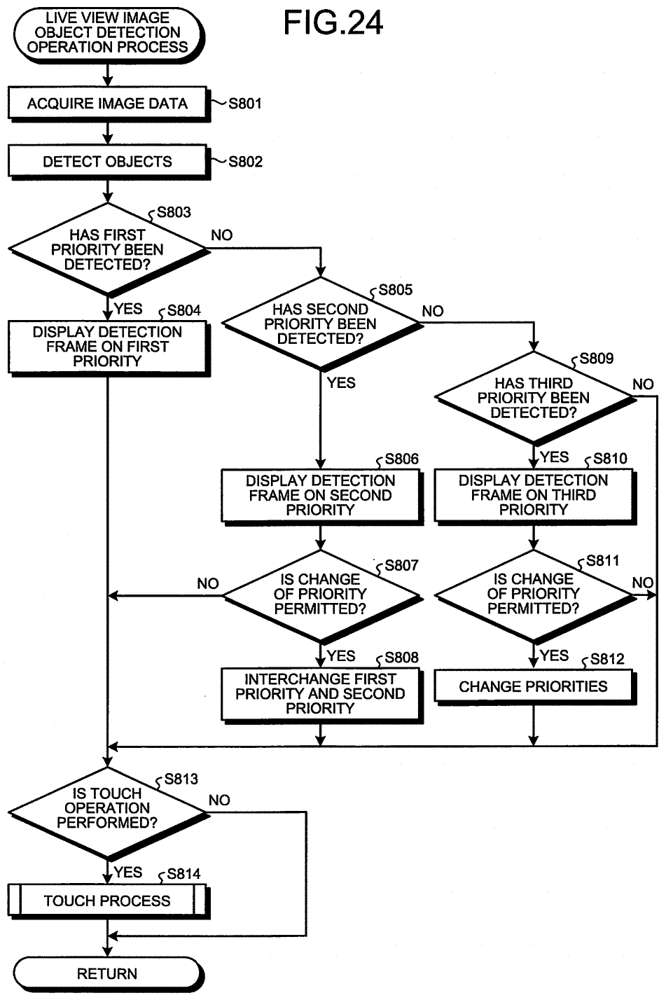

Next, a live view image object detection process performed by the image apparatus 100 will be described. FIG. 24 is a flowchart illustrating an outline of the live view image object detection process performed by the image apparatus 100. In FIG. 24, Step S801 to Step S812 respectively correspond to Step S701 to Step S712 of FIG. 21 described above.

At Step S813, if touch operation is performed on the touch panel 121i (Step S813: Yes), the image apparatus 100 performs a touch process of changing the priorities in accordance with the touch operation (Step S814). The touch process will be described in detail later. After Step S814, the image apparatus 100 returns to the main routine of FIG. 5. In contrast, if touch operation is not performed on the touch panel 121i (Step S813: No), the image apparatus 100 returns to the main routine of FIG. 5.

Touch Process

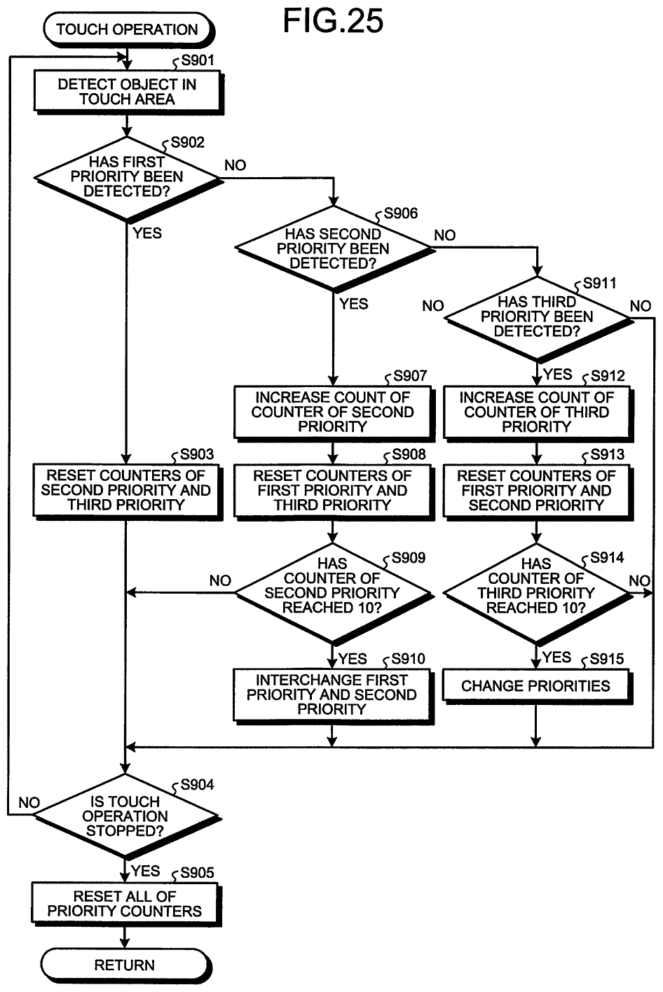

FIG. 25 is a flowchart illustrating an outline of the touch process performed at Step S814 in FIG. 24.

As illustrated in FIG. 25, the object detection unit 128b detects an object in a touch area within the image, based on a positional signal input from the touch panel 121i (Step S901).

Step S902 and Step s903 respectively correspond to Step S303 and Step S305 of FIG. 8 described above.

At Step S904, if the user stops touching the touch panel 121i (Step S904: Yes), the image apparatus 100 proceeds to Step S905 to be described later. In contrast, if the user does not stop touching the touch panel 121i (Step S904: No), the image apparatus 100 returns to Step S901 described above.

Step S906 to Step S915 respectively correspond to Step S306, Step S308 to Step S312, and Step S314 to Step S317 of FIG. 8 described above.

According to the seventh embodiment as described above, when touch operation is performed on the touch panel 121i, and if the determination unit 128d determines that the object detection unit 128b has not detected an object with a high priority in an area including a touch position that is touched, the change unit 128c increases the priorities of the objects that have been detected by the object detection unit 128b in the touch area including the touch position. Therefore, even when the number of objects to be detected is increased, the user is able to intuitively change the priorities of the objects as desired, by simple operation.

### Other Embodiments

By appropriately combining a plurality of components disclosed in the image apparatuses according to the first to seventh embodiments of the present disclosure, various modes may be made. For example, it may be possible to remove some components among all of the components described in the image apparatuses according to the embodiments of the present disclosure described above. Furthermore, it may be possible to appropriately combine components described in the image apparatuses according to the embodiments of the present disclosure described above. Specifically, it may be possible to implement the present disclosure by appropriately combining the predetermined time, the specific region, the period in which the image apparatus is moving, specific operation including the imaging operation and the zoom operation, the cancel operation of inhibiting a change of priorities, the cancel operation of restoring the priorities, the touch operation, and the like, which are described in the first to seventh embodiments.

Moreover, in the image apparatuses according to the first to seventh embodiments of the present disclosure, “units” described above may be replaced with “means”, “circuits”, or the like. For example, the control unit may be replaced with a control means or a control circuit.

Furthermore, a program to be executed by the image apparatuses according to the first to seventh embodiments of the present disclosure is provided by being recorded in a computer-readable recording medium, such as a compact disk-read only memory (CD-ROM), a flexible disk (FD), a compact disk-recordable (CD-R), a digital versatile disk (DVD), a universal serial bus (USB) medium, or a flash memory, in the form of computer-installable or a computer-executable file data.

Moreover, the program to be executed by the image apparatus according to the first to seventh embodiments of the present disclosure may be stored in a computer connected to a network, such as the Internet, and may be provided by being downloaded via the network.

In describing the flowcharts in this specification, context of the processes among the steps is described by using expressions such as “first”, “thereafter”, and “subsequently”, but the sequences of the processes necessary for carrying out the present disclosure are not uniquely defined by these expressions. In other words, the sequences of the processes in the flowcharts described in the present specification may be modified as long as there is no contradiction. Furthermore, the program need not always be configured with simple branch processes, but may comprehensively determine an increased number of determination items and perform branch processes. In this case, it may be additionally use an artificial knowledge technique for implementing machine learning based on repetition of learning by requesting a user to manually perform operation. Moreover, it may be possible to learn operation patterns that are adopted by a large number of specialists, and execute the program with deep learning including more complicated conditions.

While the embodiments of the present application have been explained above based on the drawings, the embodiments are described by way of example only, and the present disclosure may be embodied in various other forms with various changes or modifications based on knowledge of person skilled in the art, in addition to the embodiments described in this specification.

Thus, the present disclosure may include various embodiments not described herein, and various design changes or the like within the scope of the technical ideas specified herein may be made.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object detection apparatus comprising
a processor comprising hardware, the processor being configured to:
sequentially acquire image data;
detect a plurality of objects that appear in an image corresponding to the image data every time the image data is acquired;
set a priority of each of the objects;
change the priority of each of the objects based on a detection result of the plurality of objects that appear in the image; and
change an imaging parameter at a time of imaging, based on an object with a high priority.

2. The object detection apparatus according to claim 1, wherein the processor is further configured to:
determine whether the object with the high priority was detected every time the image data was acquired; and
change the priority of each of the objects when it is determined that the object with the high priority was not detected.

3. The object detection apparatus according to claim 2, wherein the processor is further configured to increase the priorities of the detected objects when it is determined that the object with the high priority was not detected.

4. The object detection apparatus according to claim 2, wherein the processor is further configured to:
determine whether the object with the high priority was detected in a predetermined time; and
increase the priorities of the objects detected in the predetermined time when it is determined that the object with the high priority was not detected in the predetermined time.

5. The object detection apparatus according to claim 2, wherein the processor is further configured to:
set a specific region in the image;
determine whether the object with the high priority was detected in the specific region; and
increase the priorities of the objects detected in the specific region when it is determined that the object with the high priority was not detected in the specific region.

6. The object detection apparatus according to claim 2, wherein the processor is further configured to:
detect a moving state of the object detection apparatus;
determine whether the object with the high priority was detected during a period in which the object detection apparatus is moving, based on a detection result of the moving state of the object detection apparatus; and
increase the priorities of the objects detected during the period when it is determined that the object with the high priority was not detected during the period.

7. The object detection apparatus according to claim 2, further comprising:
a first operating device configured to receive input of predetermined operation, wherein
the processor is further configured to:
determine whether the object with the high priority was detected when the first operating device receives input of the predetermined operation; and
increase the priorities of the detected objects when it is determined that the object with the high priority was not detected.

8. The object detection apparatus according to claim 2, further comprising:
a first operating device configured to receive input of predetermined operation, wherein
the processor is further configured to:
detect a moving state of the object detection apparatus;
determine whether the object with the high priority was detected during a period in which the object detection apparatus is moving, based on a detection result of the moving state of the object detection apparatus; and
increase the priorities of the objects detected during the period when it is determined that the object with the high priority was not detected during the period and when the first operating device receives input of the predetermined operation.

9. The object detection apparatus according to claim 7, wherein the predetermined operation is enlargement operation of enlarging a part of the image.

10. The object detection apparatus according to claim 7, further comprising:
a display configured to display the image; and
a touch panel disposed in a display area of the display in a superimposed manner, wherein
the first operating device is the touch panel, and
the predetermined operation is touch operation that is performed for a predetermined time or longer on the touch panel.

11. The object detection apparatus according to claim 7, further comprising:
an optical system having a changeable focal distance and forming an object image, wherein
the predetermined operation is operation of changing the focal distance.

12. The object detection apparatus according to claim 7, further comprising:
a second operating device configured to receive input of a cancel signal for inhibiting the processor from changing the priorities or a cancel signal for returning the changed priorities to previous priorities.

13. The object detection apparatus according to claim 7, further comprising:
a display controller configured to control the display to display, in a superimposed manner, a detection frame in an area including the detected object with a highest priority on the image.

14. The object detection apparatus according to claim 13, wherein the display controller controls the display to display information related to the priorities on the image in a superimposed manner.

15. The object detection apparatus according to claim 13, wherein when the processor changes the priorities, the display controller controls the display to display a warning on the image in a superimposed manner.

16. An image apparatus comprising:
an optical system configured to form an object image;
an imaging sensor configured to receive light of the object image formed by the optical system, perform photoelectric conversion on the object image, and sequentially generate image data;
a processor comprising hardware, the processor being configured to:
sequentially acquire the image data;
detect a plurality of objects that appear in an image corresponding to the image data every time the image data is acquired;
set a priority of each of the objects;
change the priority of each of the objects based on a detection result of the plurality of objects that appear in the image; and
change an imaging parameter at a time of imaging, based on an object with a high priority.

17. A method of detecting an object implemented by an object detection apparatus, the method comprising:
sequentially acquiring image data;
detecting a plurality of objects that appear in an image corresponding to the image data every time the image data is acquired;
setting a priority of each of the objects;
changing the priority of each of the objects based on a detection result of the plurality of objects that appear in the image; and
changing an imaging parameter at a time of imaging, based on an object with a high priority.

18. A non-transitory computer readable recording medium on which an executable program is recorded, the program instructing a processor included in an object detection apparatus to execute:
sequentially acquiring image data;
detecting a plurality of objects that appear in an image corresponding to the image data every time the image data is acquired;
setting a priority of each of the objects;
changing the priority of each of the objects based on a detection result of the plurality of objects that appear in the image; and
changing an imaging parameter at the time of imaging, based on an object with a high priority.
